(19) United States
(12) Patent Application Publication
(10) Pub. No.: US 2021/0049463 A1
(43) Pub. Date: Feb. 18, 2021

(54) LOW PRECISION EFFICIENT CONVOLUTIONAL NEURAL NETWORK INFERENCE DEVICE THAT AVOIDS MULTIPLICATION WITHOUT LOSS OF ACCURACY

(71) Applicant: Brendan RUFF, Newcastle upon Tyne (GB)

(72) Inventor: Brendan RUFF, Newcastle upon Tyne (GB)

(21) Appl. No.: 16/966,886

(22) PCT Filed: Jan. 30, 2019
(86) PCT No.: PCT/GB2019/000015

§ 371 Date: Aug. 1, 2020

(30) Foreign Application Priority Data
Feb. 1, 2018 (GB) 1801639.4
Feb. 20, 2018 (GB) 1802688.0
Jan. 29, 2019 (GB) 1901191.5

(51) Int. Cl. G06N 3/08; G06N 3/04; G06F 9/38; G06F 9/30; G06F 17/15

(52) U.S. Cl. CPC G06N 3/08; G06N 3/04; G06F 17/153; G06F 9/30036; G06F 9/3887

(57) ABSTRACT

A computational device performs the operation of a bank of convolutional filters commonly used in a convolutional neural network. The input, output and filter coefficients are represented with, a low precision of their significand which precision is preferably 3 of r bits which is sufficient so that no loss of accuracy is found in the network output. This enables replacement of the multiplications employed in such a convolutional computation device with a simple look up table for all possible product values for the significand of the input tensor and a filter coefficient. The accumulated result for each filter across its coefficients is efficiently formed by summing the shifted and filter center aligned output of this look up table. The electronics or software required to perform the convolutional filtering operation is greatly simplified and has much less computational cost than an equivalent computational device that employs higher precision and multiplications.

### BACKGROUND

Convolutional neural networks (CNN's) particularly for visual perception for computer vision tasks such as object recognition and detection or semantic segmentation or 3D reconstruction or any other typically process input data such as RGB images comprising a 2D matrix for each of multiple colour planes and can process other input (e.g. depth). This input is typically treated as a 3D tensor with Y and X dimensions forming a 2D slice of the input and the depth dimension D indexes the different channels in the input. This input is processed by a feed-forward or recurrent network of many layers of convolutional filters or fully connected filters with diverse interconnection wherein each layer processes the output tensor of the previous layer starting with the first layer that processes the input data, and typically each layer comprises a plurality of identical number of dimensions and size of filters. This CNN has a huge computational cost though the network essentially is mostly performing the simple task of the well-known digital filter wherein each filter is applied identically at every unique spatial point (y,x) in the filter's input tensor and this filter multiplies the input data around a (y,x) point offset by the position of the corresponding coefficients in each filter here focussing on the example of 3D filters within a 3D tensor volume of the same shape as the filter and accumulates the total weighted sum of input points to the filter and correspondingly located filter coefficient into an output value at the corresponding output point (y,x) for that filter this forming a 2D output channel in the filter bank output 3D tensor O, this being the standard convolution or correlation operation where the digital filter is applied at all possible 2D input positions (y,x). Though the input tensor to the filter may have any number of dimensions including one which is the special case of a so-called fully connected filter and so no convolution is performed across the 2D spatial locations and this single dimension being formed typically by flattening all the input dimensions to a single dimension, for computer vision problems to which the present invention is particularly suited the 3 dimensional (3D) tensor case for input and output and filter tensors is typical where the filter is applied to every spatial position within a 2 dimensional (2D) slice with position coordinates (y,x) and where the third dimension is usually referred to as the depth with index i so giving a complete point reference of (i,y,x) and usually and preferably though not limited thereto the output space of the filter has the same 2D size as the input this being achieved by padding the input 3D tensor along its 2D borders in Y and X dimensions typically with zero values so that the border width is adapted to the filter 2D size and the filter center point so that there is a sufficiency of border points for the filter to be applied to the outer perimeter of points in the 2D input slice so that the output 2D size and input 2D size is identical and in any case the filter depth and the input depth is identical, and this case is assumed throughout this patent description though it should be understood that it is not limited to only this as the output 2D size may simply be reduced if no padding is supplied or the points near the boundary that are affected by the insufficiency of input points for the filter are simply dealt with as a special case, and all of these cases should be assumed without explicitly stating as alternatives within the present invention.

Since it is very unusual to have the case where a single filter is applied to the input tensor then it is normal practice that a plurality of filters each of which in this computer vision example is a 3D tensor is applied to the input tensor which in this sense is shared by all filters in the filter bank and to represent this plurality of filters as a single 4 dimensional (4D) tensor here referred to as W wherein each filter is indexed by f and the filter has a 3D kernel comprising coefficients indexed by subscripts (f,i,p,q) which in order represent the filter number f, the depth index i of the 2D slice of the kernel and also the input, and the 2D position (p,q) of the coefficient within the 2D depth slice of the kernel corresponding by convention to its Y position p and X position q of the point on a Cartesian grid. Typically there is one filter coefficient for each (i,p,q) point in the kernel for each filter which is known as a dense filter but this is not assumed within this patent description for the present invention and in particular the case of a sparse filter is also applicable and preferable as it requires less computation wherein at least one and preferably a plurality of coefficients within the kernel is omitted and are considered to have zero value so these zero coefficients may either be present in a dense filter with zero value or simply be omitted in a sparse representation, for instance a list of (f,i,p,q) coefficient non zero values in which list no zero values are present. As will be seen in the detailed description of the present invention such sparse list based representation or dense tensor representation has no impact on the operation or design of the novel computational device that treats the filter bank as a whole as a sequence of coefficients, i.e. coefficient sequentially.

In a CNN application the output of each filter is typically further processed by adding a scalar bias and then applying a so called nonlinear operation, for instance a simple threshold and then half wave rectification that sets all negative values to zero leaving only zero or positive values, and this is a relatively low computational cost elementwise operation of linear algebra, and other operations such as elementwise scaling or mean subtraction are typically performed and usually these are not considered to be part of the convolutional filter but as will be seen it may be advantageous for these to be optionally integrated within the present invention. Each filter is either dense are sparse, and typically though not limited thereto the filter has a regular and typical rectangular or even square 2D footprint, e.g. 3×3 or 5×5 or 7×7, and is centred in the sense that the output location corresponds to the location of the symmetry center of the filter thought this is not a requirement and indeed trained filters are typically not constrained to be centred but in practice the computational operation is centred implicitly and by default. The order of accumulation of the weighted input is not mathematically important for the result which allows the filter computation to be mapped onto processing resources or custom silicon, e.g. a systolic array computation, and this has been a known technology for many decades and many such devices are flooding onto the market at this time because of the great commercial potential for deep learning and AI.

Sparse here simply means that some of the weights in the filter are omitted so a dense regularly shaped filter simply has holes and the computation of the missing weights, i.e. coefficients, is omitted and thereby reducing the computational burden. In this description the coefficient indexing scheme for a regular dense filter will be used throughout even though some combination of indices are not represented for the case where the filter is sparse and both sparse and dense filters are equally processed in the current invention. Since the filter coefficients multiplied by input data may be accumulated in any coefficient order and Y and X and depth order and any number of filters may be partially processed in parallel then all of the typical parallel processing techniques and architectures may be safely assumed to apply and are not further discussed.

Convolutional neural nets (CNN's) comprise many layers of filters, a layer being a group of identically shaped filters notwithstanding coefficients may be omitted and so the filters may be sparse wherein each coefficient typically has its own unique real value. CNN's are typically trained using some loss method and training method in which many if not all the weights are updated repeatedly with small real valued changes until a satisfactory convergence to a final acceptable accuracy is achieved. Once this training process has completed then the coefficients are usually fixed, though they could be updated online from time to time, and then the CNN and its component convolutional filters are processed in a so called inference pass i.e. the output of each filter is computed in turn within the architecture of the CNN, wherein a coefficient of a filter can only be processed when its corresponding input is available. Because of the huge interconnectivity within the acyclic computational graph of a CNN then there are many possibilities for parallelising this task, but the simplest most regular approaches usually are adopted as this maps well to massive SIMD parallel hardware implementation in which one input map (i.e. 2D slice through the input tensor) of that map is processed by all filters and the results of the filters accumulated slice by slice noting that each slice has many coefficients applied, eg a D×3×3 filter has 9 coefficients applied to the same 2D slice within an input tensor of dimensions D×Y×X, i.e. has D 2D slices. Another obvious approach is data parallelism where the input tensor is split into a grid typically of a rectangular or square 2D pattern so that 2D patches called tiles of the input are processed by different processors that apply all filters, or any combination of both or indeed other parallelizing methods.

Of high importance to computational cost for a bank of convolutional filters is numeric precision and the particular implementation of the computational device that performs the individual filter weighted sum of products, i.e. convolutional filtering, and this is the subject of the present invention. During training the filters within the CNN naturally become immune to a large variation in their input, and the property of being immune to this variation is called being robust. The author of this patent has noted by experiment that though the range of coefficients within a given filter may span several orders of magnitude, the precision of the significand of the coefficients which is the number of binary bits after the binary point, i.e. the fractional part, needed to maintain CNN output accuracy is actually very low for coefficients and data, and this makes complete sense as if a coefficient were highly specific in fractional value then the filter could not be robust, i.e. immune to variation in the input channel for that particular coefficient ipso facto, and in any case a filter must be robust to some variation in each channel of its input which could be considered noise in the channel signal and in this case there is no purpose to representing the coefficient value at a precision higher than the range of this noise though current state of the art typically represents using at least 8 bits of precision claiming that this is required to maintain CNN accuracy. In practice the author has experimentally determined that 3 or 4 bits of significand for all coefficients and input data and filter output is all that is necessary for equivalent final CNN output accuracy, and even 2 bits or 1 bit of significand loses only a small but significant amount of accuracy in the network output, and 5 bits or higher precision does not improve upon the 4 bit variant and so is not necessary. In this low precision case the exponent of the floating point real value is maintained within the range of the equivalent high precision CNN and only the significand is rounded to the nearest quantised value, which is important, and truncated. As will be introduced later, this leads to a very interesting possibility for greatly simplifying the weighted sum of products of the filter when considering a multiplicity of many such filters applied to the same input and leads to a simple computational device that performs this operation without any multiply operations and instead uses only simple add or subtract and binary bit shift for alignment of the accumulator and the partial result for each filter coefficient.

The main stream science and technology for efficient CNN inference has tended towards 8 bit signed integer implementation of the filter with appropriate pre-processing of the exponent so that all data and coefficients lie within an 8 bit scaled integer range. State-of-the-art that uses exponent range normalisation to reduce the precision of a floating point number to an 8 bit integer allows 8 bit ALU operations to be performed including 8 bit coefficient and data multiplication. It is the object of this invention to provide an alternative so that convolutional filter multiplications may be entirely replaced by simpler addition and bit shifting that are less costly in terms of silicon real estate and power consumption but critically without significant or indeed any loss of network accuracy and by so replacing these multiplications within the novel computational device then the present invention supplies a highly efficient novel computational device for deploying a complete CNN within embedded and data center applications, and indeed the novel device may also be used during CNN training to compute reduced precision backpropagated error signals by separately keeping high numeric precision versions of the reduced precision filter and other coefficients such as bias and scaling terms commonly used in CNN's which high precision coefficients are updated with the low precision gradients that are computed from the reduced precision convolutional filter output maps that were computed in the forward pass and reduced precision error maps then computed in the backward pass, and thereby the novel reduced precision convolutional filter computational device of the present invention may be used both for efficient training of a CNN and for efficient inference.

For brevity the word processor or abbreviation CPU in this description should be read as pertaining to any possible physical processing device implementation of the processing means for the novel inventive device described herein, for instance an actual CPU, a GPU (graphics processing unit) that contains many processors in an array with shared memory, an SoC (system on chip) that may contain many processors into accelerators designed specifically to accelerate multiply-accumulate operations in parallel, a SIMD vector co-processing device for instance the NEON device supplied on an ARM processor, an FPGA device configured to process data and coefficients in local memory, a custom ASIC whose electronics architecture explicitly performs all operations, or indeed any combination of these on a single chip or across a multiplicity of interconnected chips. Also, where applicable a processing means that applies to a processor as just described implicitly refers to a configurable software means. For instance, with an ASIC implementation such software would likely be a combination of fixed register values and a microcode for moving data around and activating hardware components and is just a special case of a general-purpose CPU style processor.

### DESCRIPTION

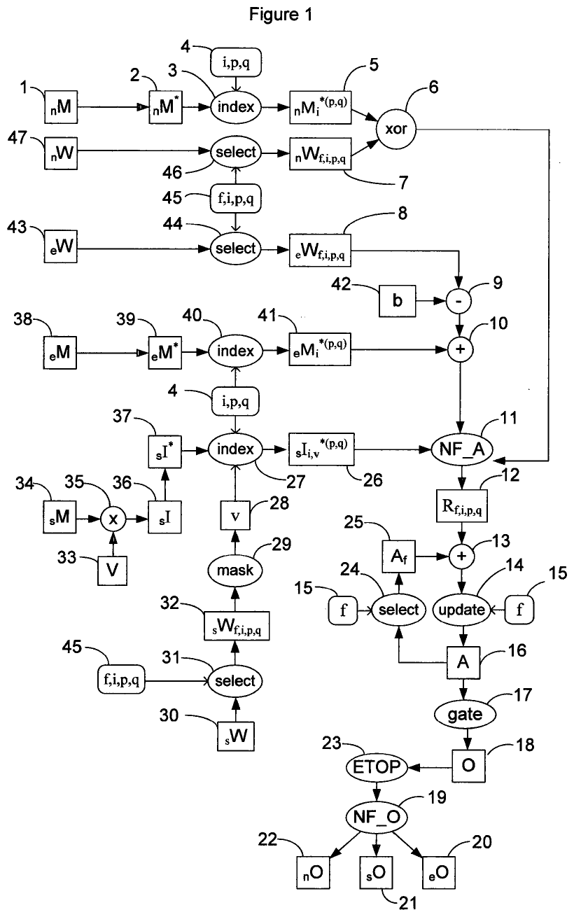

The present invention is a computational device with the preferred embodiment shown in detail in FIG. 1 that performs a 3D convolutional filter operation for a real valued 4D tensor bank W of such filters each filter W_{f} of which is applied at all 2D (y,x) locations, i.e. convolved with, to a real valued 3D input tensor M that is a stack of depth D of 2D slices known as maps of 2D height Y and width X and which input and filter coefficients are represented with a finite and low arithmetic precision significand, a separate exponent, and a sign bit, which 3D input tensor is typically the input for convolutional neural nets for computer vision applications but the present invention is not limited to only 3D input tensors and the 3D variant is described by way of example only and for instance the input could be a 2D tensor that represents for instance a time series of 1D vectors as one example, and which figure further illustrates the novel means for creating and sharing low precision and padded significand product intermediate results ₛI* [37] that are further indexed by the filter depth index i and shifted to form a filter center aligned 2D tensor ₛIᵢ*^{(p,q)} [26] that is accumulated by combining the individual coefficient sign ₙW_{f,i,p,q} [7] and exponent ₑW_{f,i,p,q} [32] with the input maps so indexed and shifted exponent ₑMᵢ*(m) [41] and sign ₙMᵢ*^{(p,q)} [5] with the shared intermediate factor results ₛIᵢ*^{(p,q)} [26] and further numerically reformatted to a higher significand precision either in the numerical format of fixed point or a floating point representation by means NF_A [11] that performs this numerical reformatting to the numerical representation of the accumulator tensor A [16], and this combining of signs and exponents and significand product followed by numerical reformatting so forms the partial convolution result 2D tensor R_{f,i,p,q} [12] for the filter coefficient indexed by (f,i,p,q) very efficiently compared to the standard convolutional filter operation at this avoids any multiplication once the shared intermediate significand tensor ₛI* [37] has been computed and even that may be computed it will be shown without multiplication and in any case it is not computationally expensive to form this shared tensor.

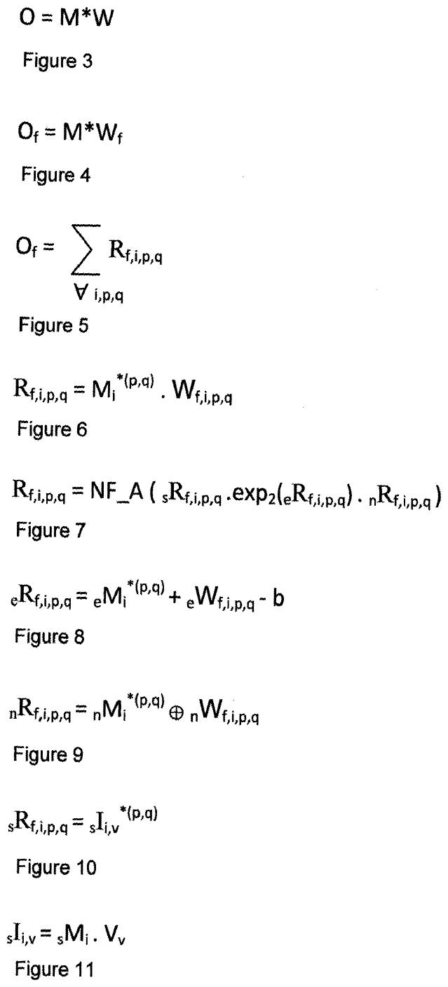

FIG. 1 shows the dataflow for the preferred embodiment of the computational device of the present invention whose computational operation is described in the equations in FIGS. 3 to 11 and which computational device performs the operation described in the equation of FIG. 3 noting that the arrows with a solid head denote data movement whereas the lined head denotes a control input from indexing means which indices are the letters in the round cornered boxes [4] [15] [45] in which f is the filter index, i is the depth index in the filter kernel and also in the input data, and (p,q) is the 2D index in a slice of the filter kernel noting that these can be negative values as well as positive or zero and an index of (0,0) is at the filter center. In summary this computational device creates a padded intermediate significand tensor ₛI* [37] that is shared across the computation for all filters within the filter bank which comprises the main inventive step as it avoids computing this for each filter coefficient separately since many coefficients share the same significand value which is typically a small set such as 16 values for a 4-bit significand for instance, and tensor ₛI* is the zero or data padded version of the product of the significand input tensor ₛM [34] and the broadcast vector V [33] which broadcasting refers to creating a vector of the product ₛM.Vᵥ where Vᵥ is the scalar value in V at index v for all values of v these values being (1+v) and so representing all possible non zero significands for a b bit precision significand, and then this intermediate tensor ₛI* is simply indexed by (v,i,p,q) to extract the (p,q) shifted subtensor ₛI_{i,v}*^{(p,q)} [26] that is then combined with the indexed and shifted sign bit tensor ₙMᵢ*^{(p,q)} [5] and exponent tensor ₑMᵢ*^{(p,q)} [41] of the input and combined with sign ₙW_{f,i,p,q} [7] and exponent ₑW_{f,i,p,q} [32] of the filter coefficient and further reformatted to the numeric format of the accumulator A [16] and thereby form a per coefficient partial convolution result tensor R_{f,i,p,q} [12] that is then arranged to be accumulated with the corresponding 2D slice A_{f} [25] of the accumulator means A [16] one coefficient at a time, and once all coefficients have been accumulated across all filters the convolutional output O [18] is made available via output gating means [17] for optional post processing with elementwise tensor processing means ETOP [23] and is finally reformatted back to the low precision format of the input to the device ready to be processed by another such convolutional filter bank device. It should be noted that the computational device performs the highly expensive convolutional operation without any multiplications and instead uses the elementwise addition operator of linear algebra to combine the intermediate maps ₛI by indexing with v and *(p,q) positional shift and since the addition operator is very inexpensive to compute then the novel convolutional computational device presented offers huge processing cost and power consumption advantage over the current state of the art convolutional accelerator devices that employ at least 8 bit multiplication and accumulation of coefficients and data and this low precision shared intermediate product arrangement and shifted indexing means combined with the separate shared and similarly shifted input exponent tensor and sign tensor and the exponent combination means forms the novel inventive step of the present invention that relies on the robustness property of the CNN to permit this low precision significand representation that in turn allows the intermediate shared significand product tensor to be efficiently computed once and shared and within a tractable size of memory particularly if the processing is performed one 2D slice of the input significand at a time and also if the input is tiled and processed one tile at a time. Also this avoidance of multiplications in the computation of the filter output allows the device to be implemented in a software embodiment on any SIMD processing device including fixed point i.e. integer devices but is best embodied in a custom electronics device such as an ASIC or FPGA where the numerical format of the intermediate significand tensor and the accumulator may be arranged to optimise the memory use and computational cost directly according to the minimal precision needed which is preferred to be 3 or 4 bits of significand for the intermediate significand maps but not limited thereto and 16 bits fixed point for the accumulator means but not limited thereto.

The linear algebra equations that explain the operation of the novel inventive computational device use a superscripted *(p,q) notation for indexing a 2D subtensor from a zero or otherwise padded 3D tensor for several of the 3D tensors stored in memory and this means being represented in FIG. 1 with [3] and [27] and [40], which indexing means firstly selects the i^{th} 2D slice from the padded input 3D tensor and then selects the (p,q) offset 2D subtensor within that slice which subtensor has the same 2D size as the 2D size of the original unpadded 3D tensor, which subtensor is the output of the indexing operation, and in which the (p,q) offset is relative to the origin of the unpadded 2D slice of the original tensor within its padded version so that an offset of (0,0) gives the corresponding i^{th} 2D slice of the original unpadded 3D tensor. This indexing means requires that the original 3D tensor H, which letter is chosen as a placeholder for any such 3D tensor, is firstly padded around its 2D boundary for instance with zeros to form the padded 3D tensor H* and in which the 2D padding border within each slice of the padded 3D tensor H* has a sufficiency of points so that a 2D subtensor of the same 2D size as the unpadded input 2D slice can be offset by (p,q) within the padded 2D input slice so that this subtensor is fully contained within the so padded 2D input slice for all (p,q) where the (p,q) index refers to the p^{th} row and q^{th} column position of any filter coefficient within the filter bank W of the novel computational device, and the padding border width is adapted to the range of p and q values within the 4D filter bank W to give this sufficiency of padding noting that these indices are relative to the filter center here to simplify the indexing arithmetic and so both positive and negative indices exist. Also please note that in practice the padding operation will be optionally integrated into the storing of the 3D input tensor when it is placed in computer memory for efficiency rather than as a separate copy-with-padding operation for instance by setting these border values to zero or by copying a larger tensor H that has data within this border already.

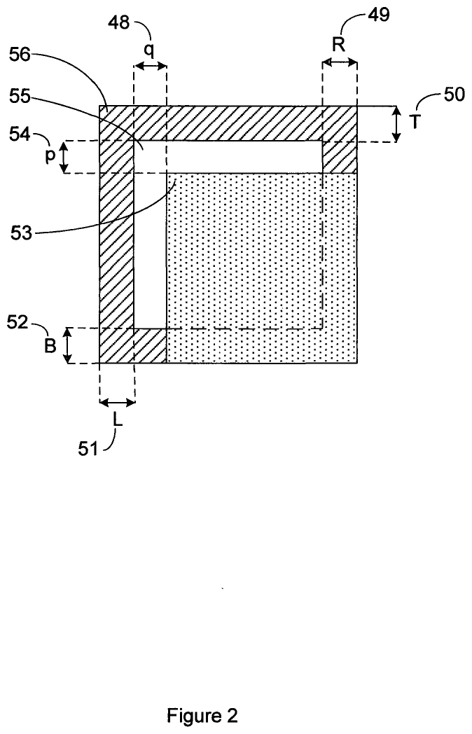

FIG. 2 explains the annotation and principle used here to index into a 2D padded matrix preferably in-place in memory for a software embodiment and with custom shift electronics for an ASIC or FPGA embodiment and in which the padding is preferably with zero values or alternatively values taken from the border with neighbouring tiles of data if tile based data partitioning is used.

This subtensor offset indexing means is demonstrated in FIG. 2 for a 3×3 filter kernel 2D slice where the filter kernel height k_h=3 and filter kernel width k_w=3 which requires 1 point of padding around the boundary of the 2D input tensor slice to support p and q values in {−1,0,+1} and an output subtensor that here has a size that is two points less than the selected by index i padded input 2D slice. This general mechanism illustrated in FIG. 2 indexes the 2D subtensor Hᵢ*^{(p,q)} [53], that is shaded, from the zero padded 3D input tensor H* (not shown) that is the padded version of the 3D tensor H (also not shown) by firstly indexing the i^{th} 2D slice and padding it to form Hᵢ* [56], that is hatched and in the background and so not fully visible behind [55] itself behind [53], noting that for reference the white square [55] is the embedded position of the original i^{th} 2D slice Hᵢ of H within Hᵢ*, and where Hᵢ*^{(p,q)} [53], the shaded square, has the same 2D size as the unpadded input slice Hᵢ and is further arranged to have a positional shift (p,q) relative to the embedded position [55] of the unpadded input 2D tensor Hᵢ within the padded 2D tensor Hᵢ*, this reference position (p=0,q=0) being the indexed 2D tensor Hᵢ*^{(0,0)} that is identical to the input 2D slice Hᵢ, and which shift in the Y dimension that is vertical and increasing down the page is given by p [54] and which positional shift in the X dimension that is horizontal and increasing right is given by q [48], and which unshifted reference 2D tensor Hᵢ*^{(0,0)} [55] has a padded border around its boundary at its top of T [50] rows, at its bottom of B [52] rows, at its left of L [51] columns, and at its right of R [49] columns which padding preferably has the value of zero or is data from neighbouring tiles in the tiled case and here R=T=B=L=1 by way of example for a 3×3 centred filter with both p and q have values in {−1,0,+1}, and this indexing means of the padded 3D input tensor H* by indices (i,p,q) thereby forms the 2D tensor annotated by Hᵢ*^{(p,q)}. Note that in this indexing mechanism the 2D tensor Hᵢ and Hᵢ*^{(0,0)} are identical so that an element in these 2D tensors indexed at point (y,x) gives the same value i.e. Hᵢ(y,x)=Hᵢ*^{(0,0)}(y,x), and in the FIG. 2D tensor Hᵢ*^{(1,1)} is illustrated shaded [53] which is offset one point down and right within Hᵢ* [56] as p=1 and q=1.

This general mechanism applies in particular to the (i,p,q) indexed intermediate 2D map ₑMᵢ*^{(p,q)} [26], to the (i,p,q) indexed input data exponent 2D map ₑMᵢ*^{(p,q)} [41], and to the (i,p,q) indexed input data sign 2D map ₙMᵢ*^{(p,q)} [5]. The asterisk notion *(p,q) is chosen to be reminiscent of a based offset memory referencing operation because the software embodiment of this mechanism in the present invention is provided by relatively offsetting the base address of Hᵢ within Hᵢ* by p rows and q columns to give the base address of Hᵢ*^{(p,q)} in-place within the memory address range occupied by Hᵢ* and thereby avoids any data copying to a separate memory space and so is an inexpensive indexing means both in memory usage, i.e. none, and in processing, i.e. none other than performing the addressing arithmetic.

In particular it is a further object of the present invention and preferred embodiment of FIG. 1 that optionally the exponent input tensor ₑM [38] and optional input sign tensor ₙM [1] and intermediate scaled input significand ₛI [36] are stored in padded format already when copied into device memory and so a separate padding means for these tensors to support the indexing means may be omitted in this case.

Next some general principles are introduced concerning the arithmetic precision and format that is used in the present invention and the implications for how a convolutional filter could be implemented efficiently based on low precision for input operands and intermediate data, and in particular to explain the novel principle upon which the inventive step is based.

A real number here is represented in digital format with a finite and small number of bits sufficient to allow the operation of the computational device to have an accuracy equivalent to an embodiment that has a high precision digital real number representation. The digital format of a real number is represented in the present invention in three parts comprising the significand, the exponent, and optionally the sign bit similar to for instance a standard floating point number and such may indeed be used in one embodiment, but at a lower significand precision, which typical floating point numbers have typically 16 or 32 bits for the total representation and 10 or 24 bits encoding of the significand respectively, the significand being the fractional part of the number that is multiplied by the base 2 exponent which is 5 or 8 bits respectively here which is generally sufficient for the dynamic range of data and coefficients within a deep CNN. For arbitrary numerical computation the significand precision is vital for mathematical accuracy, however the author has noted that for a CNN comprising many interconnected convolutional filters trained to a given task the computation of the convolutional digital filters within the net learns to be robust to variation in the input to the net and to input at intermediate layers of the net and thereby learns also to be robust to reduced precision both of the significand of the input data to a filter and of the filter's coefficients, as a direct consequence of the training procedures employed which are many and varied but all seemingly arrive at the same significand precision robustness which has been determined experimentally to be 3 bits for very slight reduction in final CNN output accuracy and 4 bits for no apparent loss of precision, and even 2 bits provides only small reduction in accuracy and curiously 1 bit is still quite accurate though it loses significant accuracy typically of around 2% depending on the net design and the task and data. Note that with standard floating point representation the leading binary 1 before the binary point is omitted and is implicit since the zero value is encoded within the exponent term.

The number format of the present invention is based upon a low precision after the binary point for the significand of data and filter coefficients, for instance 2 or 3 or 4 or 5 or 6 bits of precision and preferably 3 or 4 bits of precision which low precision fractional part of the significand is optionally further extended with a most significant bit before the binary point that is either zero for the special case that the number is zero, or it is binary 1 for nonzero numbers but noting that the standard floating point implicit representation is also an alternative embodiment in which case the zero value is encoded within the exponent term. Here the precision is reference by b and refers to the number of binary digits after the binary point and so in one embodiment the precision is b=3 bits and significand is 4 bits for the input and output maps of the filter and all filter coefficients, but not limited thereto as any significand representation with such a reduced precision could be created as an embodiment with custom electronics design for instance with ASIC, VHDL specification, or FPGA since such representation would not be limited to off-the-shelf processing technology and numeric formats for operands. This example is the explicit representation of a 3 bit floating point number's significand and the most significant bit (MSB) is explicitly provided for the reason that the leading most significant bit before the binary point simplifies the computation when the embodiment is software based as it allows to encode the special value of zero directly and this is particularly useful for an embodiment that utilises a typical arithmetic logic unit (ALU) available on most modern processing devices, i.e. a CPU and in particular an accelerator coprocessor such as the NEON unit available on many ARM processors and the like. As will be shown later, larger values of b than the preferred range exponentially increase memory storage size of the intermediate computations upon which the novel invention is based for efficient computation and in particular becomes impractical for b>6 and in any case such increased precision has been found by the author to have little or no benefit beyond a value of 4 to the accuracy of a convolutional filter and CNN comprising a network of many such filters when that CNN has been trained sufficiently to be robust. As with standard floating point this gives a significand that, if not zero, is in the range 1 to (2-granularity) where granularity here for b=3 is 2⁻³ i.e. 0.125.

The binary shift part of the reduced significand precision real number of the present invention, i.e the binary exponent, is separately stored for instance as a 2's complement signed number but not limited thereto and may have an optional bias in this shift as with standard floating point exponent for the purpose of adjusting the numeric range of the real number so represented, and in particular the exponent means here is encoded as one of 3 or 4 or 5 or 6 or 7 or 8 or 9 bit 2's compliment (hereafter referred to as TC) number though not restricted to those values so for instance higher dynamic range could be encoded with more bits though a lower range would not likely be useful for a CNN. The cases of 5 or 8 bit exponent is however the preferred values for the embodiment here as software running on a computer processing device such as a CPU or GPU or arithmetic coprocessor device (e.g. ALU or SIMD vector processing device) as these are supported natively for addition operations and also within format conversion operations. However for a fixed point processor it is advantageous to select a 4 or 8 bit exponent representation so that the exponent values are an integer factor of the memory width and bus widths for load/store and binary shift and add/subtract hardware available on such off-the-shelf devices and so 4 or 8 bit exponent values may be efficiently packed to match a computer processor and memory word of 8 or 16 or 32 or 64 bits noting that pack-unpack is an option available for most high performance processors on loading to or storing from ALU registers or for memory-to-memory copy operations and usually common SIMD (single instruction multiple data) vector arithmetic units have lanes that are 4, 8, 16, or 32 bit and indeed combinations thereof and so 4 or 8 bit exponent representation is well suited to efficient processing on such processing devices and storage in such memory devices. Note that the separate significand and exponent and sign representation is very convenient for multiplication of two so represented real numbers, i.e. operands, since such operation involves a simple add of the exponent values and separate multiplication of the significands here at reduced precision relative to that which would be needed for a fixed point representation of equivalent numeric range, and the sign bits of the two operands may be combined by logic or multiplication or programmatically. For all embodiments of the novel computational device here the number of the bits for representing the exponent part of the real number do not affect the inventive feature and should be selected according to the available hardware on which the device is implemented and for the dynamic range desired for the data and coefficients.

FIG. 3 is the general equation for the real valued tensor output O that results from applying a real valued convolutional filter bank with coefficients tensor W comprising a set off individual convolutional filter kernels to an input tensor M at all (y,x) locations assuming a sufficiency of padding around the input tensor 2D boundary if so desired, and for this operation in the 3D input and filter example described in the preferred embodiment of the present invention then O and M are 3D tensors that have the same sized width and height dimensions, X and Y, so that there is an output (y,x) indexed point corresponding to each input (y,x) indexed point, and in this case W is a 4D tensor of real valued scalar coefficients individually indexed as W_{f,i,p,q} where f indexes a particular 3D filter W_{f}, i indexes the depth dimension of the filter kernel and the filter kernel depth dimension has the same size as the depth dimension of the input tensor M, and (p,q) indexes the position of a filter coefficient within a 2D slice of the 3D filter kernel where p is the row index and q is the column index within the 2D slice W_{f,i} of the 3D filter kernel W_{f}, and this equation represents the standard convolutional filtering operation of the filter bank W on the input M which operation is denoted by the * notation.

Referring to the equation of FIG. 4, one 2D slice or map O_{f} of the 3D output tensor O is computed for each 3D filter W_{f} within the 4D filter bank W applied by convolution to every (y,x) point in the 3D input M noting the requirement for a sufficiency of padding around the boundary of each 2D slice thereof, for instance zero padding.

FIG. 5 is an equivalent equation for computing the 2D output tensor O_{f} of FIG. 4 that demonstrates an alternative formulation as the sum of 2D tensors R_{f,i,p,q} for all (i,p,q), i.e. across all coefficients within the filter W_{f}, and in which all 2D tensors R_{f,i,p,q} have the same size as and are aligned to O_{f} so that each 2D tensor R_{f,i,p,q} is the result of one filter parameter W_{f,i,p,q} convolved with its correspondingly indexed and padded input map 2D slice Mᵢ, and this single coefficient convolution being equivalent to simply scaling the entire map Mᵢ by the scalar filter coefficient W_{f,i,p,q} with appropriate padding and 2D position shift (p,q) of the 2D slice Mᵢ for the position (p,q) of the filter coefficient within the filter kernel 2D slice, so that by simply adding using elementwise tensor addition the 2D tensors R_{f,i,p,q} for all (i,p,q) for filter f noting that this filter may be sparse then this simple linear algebra tensor sum results in the 2D output map O_{f} that is equivalent to the convolutional formulation of FIG. 4. Note that the Greek notation sigma with subscripted “for all” (i,p,q) means to sum the indexed R_{f,i,p,q} tensors using elementwise addition across all valid values of (i,p,q) within the filter kernel W_{f,i,p,q}.

Referring to the equation in FIG. 6, each 2D tensor R_{f,i,p,q} is the product of its corresponding real valued scalar filter coefficient W_{f,i,p,q} and the (p,q) shifted subtensor of the padded 2D i^{th} slice Mᵢ taken from the 3D input data M which so indexed 2D slice is referred to as Mᵢ*^{(p,q)} where the superscripted *(p,q) annotation for Mᵢ*^{(p,q)} denotes the shifted subtensor means previously described in FIG. 2 applied to 3D input tensor M. Note also that in this equation (i,p,q) can be a subset of all possible such values within a dense filter such that this formulation can perform coefficient sequential accumulation for a sparse convolutional filter using the linear algebra of 2D tensors and note that the coefficient order of accumulation is not important.

FIG. 7 shows the general formulation of the reduced precision real valued 2D tensor result R_{f,i,p,q} of the present novel invention that is numerically the elementwise tensor product of its 2D tensor of significands ₛR_{f,i,p,q}, 2D tensor of exponents ₑR_{f,i,p,q} and 2D tensor of signs ₙR_{f,i,p,q} noting that at this point no specific format for accumulating the partial results R_{f,i,p,q} has been specified, and so here R_{f,i,p,q} for the novel computational device is the numerical reformat operation NF_A(ₛR_{f,i,p,q},ₑR_{f,i,p,q},ₙR_{f,i,p,q}) that is specified by the means NF_A [11] of FIG. 1 which abbreviation stands for “numerically reformat to the format of the accumulator A”, which means NF_A is represented here as a mathematical function that converts from the real valued digital representation (ₛR_{f,i,p,q},ₙR_{f,i,p,q}) to any arbitrary numerical format for accumulation of the filter over its per filter coefficient partial results R_{f,i,p,q} and in particular this representation could be a fixed point format with arbitrary position and separate bias of this position for the binary point as desired and for instance is an 8 or 16 or 32 bit length format by way of example but not limited thereto, and in particular could be a floating point format for instance the standard IEEE 754 full or half precision floating point format that has 8 bit exponent and 24 bit significand or 5 bit exponent and 11 bit significand respectively for implementation on standard CPU or GPU processors and ALU or SIMD coprocessors or any other precision variant if custom electronics means are provided for instance 8 bit significand and 7 bit exponent with 1 sign bit packed into a 16 bit word. In the present invention the format for the accumulation of the 2D tensors R_{f,i,p,q} has no bearing on the inventive step and is simply adapted to be any format suitable for the hardware upon which the device is implemented. In particular the precision of the significand of the accumulator should be larger than b and in general should be adapted to be large enough so that the accumulation of R_{f,i,p,q} does not numerically overflow or underflow in such a precision. Note also that in general the parallel implementation of this equation across many processors for instance in a GPU or SIMD device would likely tile the data with tile border overlap adapted to the filter kernel's 2D size for padding across the available processors.

The equation in FIG. 8 shows the computation for the exponent part ₑR_{f,i,p,q} from the equation of FIG. 7 for a particular filter coefficient indexed by (f,i,p,q) that is formulated by summing of the exponent ₑW_{f,i,p,q} of the filter coefficient W_{f,i,p,q}, noting that this is fixed and constant across all positions (y,x) in the input exponent map i.e. it is broadcast to all positions in the 2D tensor, with the fixed exponent bias −b needed to account it will be seen from the equation of FIG. 11 for multiplication by the selected shared scaled input significand map ₛI_{i,v}*^{(p,q)}, and with the exponent of the input data in the corresponding input map, i.e. the i^{th} 2D slice ₑMᵢ*^{(p,q)} of ₑM using the *(p,q) indexing means described in FIG. 2. Thereby the exponent 2D tensor ₑR_{f,i,p,q} comprises a fixed part that is the corresponding filter coefficient's exponent offset by −b broadcast to all (y,x) locations and a variable part ₑMᵢ*^{(p,q)} that depends on the input map's exponent value at position (y,x).

FIG. 9 shows the equation for the single bit sign 2D tensor ₙR_{f,i,p,q} of the real valued tensor R_{f,i,p,q} in FIG. 7 and is formulated by 1 bit exclusive OR binary operation ⊕ between the sign bit ₙMᵢ*^{(p,q)} of the i^{th} 2D slice of the padded and (p,q) shifted 3D input map sign tensor ₙM with the sign bit ₙW_{f,i,p,q} of the real valued scalar filter coefficient W_{f,i,p,q} that is a constant across the whole 2D sign map and replicate by broadcasting.

FIG. 10 shows the identity equation wherein the 2D significand tensor ₛR_{f,i,p,q} of the real valued R_{f,i,p,q} in FIG. 7 is simply the (i,v) selected 2D tensor from the padded and (p,q) indexed shared scaled input significand 4D tensor ₛI_{i,v}*^{(p,q)} that is indexed using the *(p,q) subtensor indexing means described in FIG. 2 from the unpadded shared scaled input significand 2D tensor ₛI_{i,v}, and the unshifted tensor ₛI* is shared across all filters so is computed once and then processed by all filter coefficients by selecting with (i,v) and shifting the extracted 2D subtensor by the *(p,q) indexing means. Note that this significand tensor may have values that carry an implicit exponent of 1 as the value may be 2 or larger as will be seen in the equation of FIG. 11 from which it is derived. This 2D tensor ₛI_{i,v}*^{(p,q)} is selected from the shared 4D tensor ₛI by indexing with i to select a particular corresponding 2D input significant map from ₛM and by v to select the scaled result of this map multiplied by the corresponding scalar value selected from the vector V by indexing with v.

i.e. Vᵥ as previously introduced that contains the set of all possible non zero filter coefficient significands that can be represented with (b+1) bits in numerically ascending order so that v selects the corresponding significand whose fractional part value is also v, so Vᵥ=2^{b}+v for v in the range 0 to 2^{b}−1 inclusive and arranged in ascending order here by way of example.

The equation of FIG. 11 shows the formulation for each of the shared scaled input significand maps ₛI_{i,v} which is a 2D tensor and thereby for every input map ₛMᵢ that is a 2D tensor there is arranged a set of 2^{b} 2D tensors ₛI_{i,v} each of which v indexed 2D tensor is ₛMᵢ scaled by the corresponding indexed scalar value Vᵥ selected from the vector V where Vᵥ=2^{b}+v. Note also that each ₛI_{i,v} is computed once and shared across the computation of all convolutional filters and so the overhead for this computation is small compared to the total computation for O. Also each ₛI_{i,v} may be computed for instance by fixed point (b+1) bit multiplication directly or using addition only by the procedure of assigning ₛI_{i,0}=ₛIᵢ<<b where << is binary left shift of the 2.(b+1) bit extended tensor and then in ascending order of v for v>0 by computing using the equation ₛI_{i,v}=ₛI_{i,v-1}+ₛIᵢ and so requires only sequenced addition avoiding any multiplication.

By inspecting these equations in FIGS. 3 to 11 that describe the theoretical operation of the novel computational device of the present invention it is apparent that simple linear algebra of 2D tensors combined with a small set of (b+1) shared pre-computed scaled significand 2D tensors ₛI_{i,v} with one such set for each 2D slice indexed by i corresponding to each 2D slice ₛMᵢ of the input significand tensor allows computation of the output O by a process of shifted-addition-and-accumulation one 2D slice at a time from the shared scaled significand tensor one such slice for each coefficient sequentially for a bank of convolutional filters W, and so by computing di once then the convolution result for each coefficient separately may be computed without multiplication and only using addition. So long as a b bit precision fractional significand real number format is used where b is small e.g. 3 or 4 then the working memory needed for ₛIᵢ* is small and tractable particularly if the input data is tiled into small patches and as will be shown later a patch of e.g. 32×32 can be processed in parallel as a synchronous SIMD operation of 1024 lanes so permitting massive computational parallelism, and multiple such SIMD devices can operate on the same data tile to increase this computational parallelism or indeed operate on different tiles or different depth slices for the same tile and the tile size may be increased for a wider SIMD vector or made smaller to reduce the electronics complexity for lower power devices. Note that the equations relate to the whole input tensor for the general case in the 2D Y and X dimensions and in the depth dimension and this whole tensor may be very large and too large to keep in fast memory on an ASIC or FPGA and so it is desirable that this tensor is tiled into overlapping patches each one of which or a plurality of which is then transferred to a fast memory means on the device and it is an object of this invention that this tiling means and storage on-device in fast memory means is provided in the preferred embodiment to avoid a data bottleneck that would cause stalling of the device processing pipeline.

Of course many forms of parallelism for splitting this computation between multiple processors is possible and for instance if there is a large shared working memory for storing the entire set of shared padded maps ₛI* for the entire input tensor M then one filter could be assigned to individual processors and the results collated into O, or one input data 2D slice at a time could be assigned to each processor that then processes all the coefficients that apply to that slice and then sums these partial results across all the slices to form O thereby allowing to keep the accumulator in tractably sized fast local on-device memory such as special purpose registers or L1 cache memory by grouping points from the 2D slice to SIMD lanes in the processor, or by tiling as already given as an example, or any combination of these or any other computational split as desired and as is appropriate for off-the-shelf processing electronics or indeed custom electronics.

Now follows a detailed description of the embodiment of FIG. 1 which is a computational device comprising means to perform the computational operation of a convolutional filter for a plurality of such filters that form a filter bank as described in the equation of FIG. 3, and whose coefficients are arranged by way of example as a 4 dimensional (4D) real valued tensor W, but not limited thereto, which tensor W is represented in digital format at low significand precision by means comprising a significand tensor ₛW [30] that has b bits in its fractional part after the binary point and 1 bit before the binary point which may be explicit or implicit i.e. not stored, where for instance b is in the range 2 to 6 inclusive and preferably is 3 or 4, an exponent tensor ₑW [43] with for instance 5 or 8 bits in the format of a two's complement value but not limited thereto and in particular a lower bit representation in the range 4 to 7 bits is also suitable and could for instance be a standard floating point exponent representation such as used for the IEEE754 float16 or float32, and a single bit sign tensor ₙW [47], and further the filters in the filter bank so represented may be either dense so that a coefficient value exists for all indexed positions within the tensor or alternatively sparse where at least one and preferably many coefficients have zero value and in which case the so represented coefficient tensor W preferably comprises a list of values combined with means to note the coefficient index (f,i,p,q) within an equivalent dense filter tensor for instance, and in this example the 3D output of the convolutional operation O [18] comprises a tensor that is a stacked set of equally sized 2D matrices of the same width and height as the input tensor M with one such matrix O_{f} for each filter in the filter bank W indexed by the filter index f so forming a 3D tensor which is further optionally processed by one or a plurality of elementwise tensor processing means ETOP [23] for instance by adding a scalar bias to each 2D matrix O_{f} within O [18] or subtracting its mean or weighted mean or multiplying each O_{f} separately by a scalar factor, and further the output O [18] is optionally numerically reformatted by means NF_O [19] so that the output is arranged to be represented in the numerical precision and format as the input M and in particular by its separate significand tensor ₛO [21] that has b bits in its fractional part after the binary point and 1 bit before the binary point and which precision b has a value within the range 2 to 6 bits and preferably is 3 or 4 bits, by its exponent tensor ₑO [20] arranged to be for instance 5 or 8 bits in the format of two's complement but not limited thereto and in particular a lower bit representation in the range 4 to 7 bits is also suitable, and by its optional single bit sign tensor ₙO [22] noting that the tensor operation of the means ETOP [23] may include a final rectification that clips any negative values to zero in which case a sign bit is superfluous, and in this example embodiment the input tensor M is a 3D tensor but not limited thereto that is represented by its separate significand tensor ₛM [34], exponent tensor ₑM [38], and optional single bit sign tensor ₙM [1] which are arranged to have the same precision and format as the corresponding output tensors ₛO [21], ₑO [20], and optional ₙO [22] respectively which input M is either separately arranged to be in this format if not already in this format which format is expected in the case that this input comprises the output of another such convolutional filter bank, and further the number of bits b for the numeric representation means and the numeric format and precision of the means for the significand and exponent of the output and input tensor and filter coefficient tensor W are arranged to be the same noting that for the output and input tensors the sign bit is optional for the special case where the output is rectified within the means ETOP [23], and in particular the tensor storage means for the significand and exponent and optional sign bit for 0 and M and W is either separate tensors stored in a memory space or alternatively corresponding triplets of (sign,exponent,significand) for each value within each of O and M and W are packed together one triplet per addressable word so forming a single tensor for each instead of separate tensors for each of the sign and significand and exponent and thereby facilitating in particular implementation based on ASIC or FPGA where it could be advantageous to access single real values packed into one longer word e.g. 12 bits for a 1 bit sign and 4 bit fractional significand and 7 bit two's complement exponent suitable for a 12 bit wide memory word, and further a vector of real values V [33] is supplied in memory storage means which vector comprises the set of values {2^{b}+v:∀v=0 . . . 2^{b}−1} so for instance if b=3 then V={1000,1001,1010,1011,1100,1101,1110,1111} which is the set of all nonzero significand values for a b bit precision significand representation using an explicit most significant bit whose value is 1 for nonzero values and 0 for the special case that the real value is zero regardless of the exponent value for this particular representation noting that an alternative of this embodiment is to omit the leading 1 or 0 and instead this bit is implicit in which case the special zero value must be separately represented for instance as a special value of the exponent, and this means V [33] and input significand means ₛM [34] are arranged to be multiplied as tensors by the means X [35] to form a result tensor ₛI [36] that is their product with V broadcast to the dimensions of ₛM so that for instance a 3D tensor ₛM multiplied by vector V results in the 4D tensor ₛI [36] that is a vector of 3D tensors ₛIᵢ for each 2D slice ₛMᵢ indexed by i within ₛM, and each 3D tensor ₛIᵢ is a vector of 2D tensors comprising the 2D tensor ₛMᵢ multiplied by each scalar value within V in turn and so this vector has the same length as the vector V and each element is then a 2D tensor that is ₛMᵢ scaled by its corresponding scalar value from V indexed by v so that ₛI_{i,v}=ₛMᵢ. Vᵥ, and means ₛI [36] is further arranged to be zero padded around the 2D boundary of each 2D slice ₛI_{i,v} with a sufficiency of zeros arranged so that the output O [18] is defined for all 2D positions (y,x) in this output corresponding to all 2D positions (y,x) within the input ₛM adapted for the size of the convolutional filters within the filter bank W, and this zero padded version of ₛI is stored separately in means ₛI* [37] and optionally the multiplication means X [35] is adapted so that its output is already stored in zero padded format directly to storage means ₛI* [37], and further the computational device comprises a control means for arranging data movement between processing stages and memory storage means and for sequencing selection of data and coefficients this control means being represented by boxes with rounded corners [4] [15] [45] each containing the letters corresponding to indices that select into tensors and which indices are shared across these separate boxes and comprise a single control means that is split within the figure for clarity wherein f is the filter index within the filter bank W, and i is the depth index both for the filter kernel and all tensors in the computational device, and (p,q) are the position indices in Y and X for a filter coefficient within the i^{th} slice of a filter kernel, and further sequencing control means is arranged that sequences these indices according to the order desired for processing each filter coefficient from the filter bank W and this order and range of values being dependant upon the particular choice for parallel computational processing implemented and naively for a single processor implementation this order could be for example by firstly indexing f that is the filter index, then i that is the depth slice index so that each filter is processed in turn by accessing each of its coefficients in turn by order of depth slice but noting that an efficient parallel implementation would likely access each 2D slice of the input data in turn and perform convolutional processing of the filter coefficients corresponding to this slice across all filters before moving on to the next slice of the input data, and further a control means [45] is arranged that indexes a filter coefficient by its indices (f,i,p,q) which indices are input to a selection means [31] that arranges to select the corresponding scalar element from the 4D tensor ₛW [30] thereby selecting the significand scalar value ₛW_{f,i,p,q} [32] for the corresponding filter coefficient whose fractional part is further arranged to be extracted by masking means [29] to pass only the fractional part and thereby forms the scalar index v [28] that is the index of the filter coefficient's significand ₛW_{f,i,p,q} [32] value within the vector V [33], and further this index v is arranged in combination with control indexing means (i,p,q) [4] to index into the tensor ₛI* [37] using the indexing means [27] that is the *(p,q) indexing means illustrated in FIG. 2 to form the 2D tensor ₛI_{i,v}*^{(p,q)} [26] which holds the precomputed values of the corresponding significands within the zero padded input slice ₛMᵢ multiplied by the scalar significand ₛW_{f,i,p,q} of the filter coefficient indexed by (f,i,p,q) and further shifted in 2D position by (p,q) according to the (p,q) position of the filter coefficient in its kernel noting that a negative value for p or q correspondingly shifts up or left by that amount, and by such indexing means then 2D tensor ₛI_{i,v}*^{(p,q)} is arranged to satisfy the equation of FIG. 11 to supply the significand 2D tensor ₛR_{f,i,p,q} of the equation of FIG. 9, and further the exponent ₑM [38] of the input that in this example is a 3D tensor is arranged to be stored in zero padded format ₑM* [39] arranged identically to the zero padding of ₛI* [37] which zero padded exponent tensor ₑM* [39] is further arranged to have one 2D shifted subtensor slice indexed from it using the control indexing means (i,p,q) [4] that is input to this indexing means [40] using the *(p,q) indexing means illustrated in FIG. 2, and this so indexed 2D slice ₑMᵢ*^{(p,q)} [41] thereby comprises the exponent value at every (y,x) position that corresponds to the scaled significand value in ₛI_{i,v}*^{(p,q)} [26], and further the exponent value of the filter coefficient is further arranged to be selected from ₑW [43] using the control indexing means (f,i,p,q) [45] that selects the value ₑW_{f,i,p,q} [8] using the tensor selection means [44] that extracts the so indexed (f,i,p,q) element from the filter bank's 4D exponent tensor ₑW, and ₑW_{f,i,p,q} [8] is further arranged to have the constant precision number b [42] subtracted from it by subtraction means [9] noting that this subtraction could be supplied elsewhere simply by so reducing all values in ₑW [43] by b but for clarity of explanation this subtraction is made explicit, and further the result of this subtraction that is a single scalar value is added by tensor adding means [10] to every point in the 2D tensor ₑMᵢ*^{(p,q)} [41] and thereby this 2D tensor result is the exponent value for ₑR_{f,i,p,q} in the equation of FIG. 8, and further the sign bit value ₙW_{f,i,p,q} [7] that is the sign of the currently selected filter coefficient is arranged to be selected by means [46] using control index means (f,i,p,q) [45] to select the so indexed (f,i,p,q) element from the filter bank's 4D sign tensor ₙW [47], and further the optional 2D sign bit tensor ₙMᵢ*^{(p,q)} [5] corresponding to the sign of the input value at each (y,x) position is arranged to be selected by indexing means [3] using control index (i,p,q) [4] to select the so indexed (i,p,q) 2D tensor ₙMᵢ*^{(p,q)} from the zero padded sign tensor ₙM* [2] that is arranged by zero padding the input data's sign tensor ₙM [1] and indexed using the *(p,q) indexing means illustrated in FIG. 2 noting that the input sign tensor ₙM [1] is optional as in typical embodiments the input is always zero or positive and so contains no negative values, and further the filter coefficient sign bit ₙW_{f,i,p,q} [7] is arranged to be combined by the exclusive OR operation means [6] at every point in the 2D tensor ₙMᵢ*^{(p,q)} [5] so that this result then represents the sign 2D tensor ₙR_{f,i,p,q} in the equation of FIG. 9, and further the sign 2D tensor ₙR_{f,i,p,q} output from [6] and significand 2D tensor output ₛI_{i,v}*^{(p,q)} [26] that is equivalent to ₛR_{f,i,p,q} and the exponent 2D tensor output from [10] that is equivalent to ₑR_{f,i,p,q} in the equation of FIG. 7 are numerically reformatted by means NF_A [11] to the 2D tensor R_{f,i,p,q} [12] whose numerical format is arranged to be the same as that used for the accumulator tensor A [16], and in particular this is optionally arranged to be a fixed point real value format for instance encoded with 8 or 16 or 32 bits in two's complement format but not limited thereto or alternatively a floating point format such as float16 or float32 but not limited thereto, and further this tensor R_{f,i,p,q} [12] that is the convolution result of the current filter coefficient indexed by (f,i,p,q) and its corresponding i^{th} 2D slice of the input tensor M is further arranged to be elementwise added by the adding means [13] to the f^{th} 2D slice A_{f} [25] of the accumulator means A [16] that is a 2D tensor of the same 2D size as that of the input M and has the same numerical format as the output tensor O [18], and the so added 2D tensors A_{f} and R_{f,i,p,q} forms a 2D tensor result that is arranged to replace the f^{th} 2D slice within the accumulator A [16] via the updating selection means [14], and which f^{th} 2D slice A_{f} [25] of the accumulator A [16] is selected from that accumulator by means [24] that selects the f^{th} 2D slice within the accumulator A [16], and by these selection and adding and update means the convolutional output tensor O [18] according to the equation of FIG. 3 can be accumulated into A one filter coefficient at a time across all filters in the filter bank using the indexing control means for the filter indices (f,i,p,q) and thereby once all results R_{f,i,p,q} [12], one each corresponding to a coefficient within a particular filter indexed by (f,i,p,q), have been accumulated into A [16] then this 3D accumulator tensor is arranged by means gating [17] to be moved into storage means O [18] that is the output 3D tensor for the convolutional filter bank corresponding to the equation in FIG. 3, and further the real valued numerical format of the accumulator A [16] is arranged for example to be either a floating point representation such as IEEE 754 float with 8 or 16 or 32 bits of encoding or could be a custom floating point representation for instance with between 8 and 32 bit encoding, or alternatively the accumulator may be a fixed point encoding for instance 8 or 16 or 32 bit so adapted to standard ALU and processor register bit width or could be a custom width for instance between 8 and 32 bits, and in the case of fixed point representation and in particular with two's complement sign encoding the fixed position of the binary point is arranged according to the desired numeric range at any position within the binary encoding of the number for instance with 16 bit fixed point with the binary point at the 9^{th} bit then 9 bits of fraction is represented with a precision of 0.002 and the numeric range that is represented is approximately −127 to +127, and by this adaptation of the binary point location then a trade-off can be arranged at any given bit width between fractional precision and numeric range.

The particular general embodiment of FIG. 1 allows for the output O [18] to be accumulated in A [16] in any coefficient order by arranging a sequencing for (f,i,p,q) as desired according to the form of parallelism used to perform the computation and the linear algebra for elementwise addition of tensors is employed as a SIMD operation to account for the filter operation at each (y,x) point in the input data 2D slice M; but in practice this 2D slice is typically far too large to process as a single tensor in on-chip memory for an ASIC or FPGA and also the number of lanes of SIMD would be impracticably large for a single processing device and also the data throughput would not be sustainable from large external memories and so instead an alternative embodiment splits the input tensor into tiles that overlap at their 2D borders which overlap has the same width as the zero padding previously described in FIG. 2 but in this case the padding values are the data in the border between tiles, and so in each 2D tensor R_{f,i,p,q} [12] accumulated into A [16] is split into a plurality of abutting tiles that span the 2D YX dimensions and separately the depth dimension D of the unpadded input tensor and the tiles are processed one at a time within a single device and each tile has a contiguous range of (y,x) within one input slice and the accumulation in the simplest case is performed sequentially across all filter coefficients in the filter bank that apply to the 2D tile of the input at depth i before loading the next 2D tile at the next depth noting that this tile loading can be performed in parallel to processing the previously loaded tile to avoid any delays in the processing, and thereby accumulating the tile subtensor of A [16] over all input depths i so comprising a tile sequential and coefficient sequential SIMD parallel embodiment in which each point in the tile is assigned to a SIMD lane and the number of lanes L is the number of processing elements in the SIMD vector, and further the input tile may be processed by multiple such SIMD devices for different sets of coefficients applied to the same input tile or indeed multiple different tiles may be processed in parallel each assigned to a separate SIMD device either by different (y,x) range or depth index i for the same (y,x) range.

This 2D tiling order of sequencing the processing of the entire input tensor is particularly efficient in memory bandwidth for loading the input M from and storing the output O to a large capacity memory device external to the computational device of FIG. 1 and in particular this large memory means may be a component in a 3D chip stack comprising the device on one chip and the memory means in one or more separate chips, for instance using through silicon via (TSV) to connect the separate chips, which 3D chip stack and TSV provides means for very large memory transfer bandwidth between the memory chip and the device's input tile storage means and this tiling means pays particular attention to loading and storing data sparingly and in particular loads a sufficiency of data including 2D border padding for the computation of the output for a group of filters or the entire filter bank for one tile of data within one 2D slice of the input data at depth i at a time for L lanes for SIMD operation of the device where the tile of the input data is padded with a sufficient boundary of the input data that replaces the zero padding illustrated in FIG. 2 so that the tile is arranged to have an excess of data around its 2D boundary for the convolutional filter computation to compute the output at each point in the tile so that the set of output tiles are abutting and nonoverlapping and arranged to form the complete output tensor O [18], and for the special case where the tile is close to the boundary of the slice Mᵢ then additional zero padding is arranged as necessary for instance separately in the input so that the tile is already padded when presented to the device and no further padding needs to be considered within the device in this case, and in particular but not limited thereto the tile is a square or rectangular patch for instance for 32×32 output tile size and 34×34 input tile size that includes a 1 point width border for D×3×3 filter kernels for an input of depth dimension size D, and for this example the 34×34 patch is arranged for 1024 SIMD lanes to process one point in the output tile each synchronously and simultaneously so that the entire tile can be accumulated in parallel into the accumulator A [16] via partial results 2D tensor R_{f,i,p,q} [12] in tiles of 32×32 size which are stored within a 1024 lane vector noting that the loaded input data tile may be stored directly as a vector so long as the *(p,q) indexing operation is adapted accordingly so that the shifted vector correctly chooses the correct position of each datum within the vector. In this example the accumulator for each filter is further stored within a fast access memory arranged within the device and has 1024 points with for instance 16 bit fixed point two's complement encoding thereby requiring 2048 bytes of storage per filter and there could be typically 32 to 512 filters so this requires TileMem×NumFilters i.e. between 2048×32=64 kilobytes and 2048×512=1 megabytes of storage for the accumulator fast memory.

Also if a large number of filters for instance 512 or more are to be computed then it is an object of this invention that in this case the filter bank may be split into groups of for instance 32 filters at a time to compute the output O in groups which are further concatenated in external memory so requiring far less on-device accumulator memory noting that the data tile must be loaded separately for each group of filters and so must be loaded multiple times during the computation of the entire filter bank W and 64 Kbyte is a very realistic memory size within an FPGA embodiment for instance. Also as the coefficients are accessed in a strict sequence then this accumulator memory does not need to be randomly addressable memory and could in particular be simply a selectable length FIFO (first in first out memory) embodiment so leading to a very compact and inexpensive accumulator storage means noting also that this FIFO could be off-device connected by a synchronous, i.e. not addressed, high speed data bus.

Further the input data tile may be arranged to be loaded to a duplicate shadow buffer while the previous input tile is being processed, and in this case the tile being loaded is the corresponding tile within the next 2D slice Mᵢ of the input data so that for instance a dense 512×D×3×3 filter bank has 512×3×3=4608 individual coefficients that apply to the input tile at each indexed depth within the 2D slice Mᵢ so requiring a total of 4608 processing cycles to process in a coefficient sequential ordering so the data load operation for 1024 lanes even with narrow naïve loading one input point value at a time say for 12 bit numerical representation, e.g. 1 sign bit and 7 exponent bits and 4 significand bits, has up to 4 cycles to load from external memory but of course likely the input will be loaded many lanes at a time for instance 32 lanes of 12 bit at a time which is 384 bit wide bus access requires a total of 32 parallel load operations of 384 bits per load. For an example of processing groups of 32 filters at a time then this takes 32×3×3=288 cycles to processes the 2D tile and in this case the 32 parallel load cycles may be split across 288 cycles which allows up to 9 cycles per load operation which means the processor even for a small filter bank can run at 9× the data load rate which is very realistic for slower low cost large capacity SDRAM or alternatively a fast synchronous external memory could load 9 different tiles to 9 different SIMD processors on the same physical device so for instance at 1 GHz processing rate then 1024 lanes of SIMD gives 1 TOP (terra operation) performance and synchronous load of 9 different tiles supports 9 TOPs of performance which at 2 GHz is 18 TOPs. Also in this case the processing device may further make use of the 288 cycles for processing the current tile to pre-process the loaded data for the next tile into its scaled significand tensor for instance by loading the next tile into a shadow buffer of ₛIᵢ while synchronously processing the data into the significand product term, and for instance the ₛIᵢ buffer memory could be provided with duplicate storage means for each memory cell comprising the active cell for each value and its shadow value which is further provided with means to arrange the shadow cells to be synchronous copied all in a single cycle to the active cells at the beginning of the next round of accumulation for the newly loaded 2D tile, and indeed rather than random access to this shadow buffer the data could be loaded as a FIFO means to simplify access and bus structure for loading, and in this case the load mechanism for instance could load each shadow cell via a simple look-up table (LUT) that converts the input value to MSB*V[fractional part input] where [ ] indicates a LUT operation on the fractional value which is 3 bits for a 4 bit significand with precision b=3 and is an 8 element LUT. In this example embodiment the 1024 sized tile for precision b=3 has 2³ different product variants of the input tile one variant for each possible coefficient significand so requiring 8×1024 words of 8 bits to represent each value in the (i,v) indexed tile of ₛI_{i,v} where i is a constant for a given tile since the significand product requires 2(b+1)=8 bits width because of the explicit MSB and so can directly represent the range zero to 4-2⁻³ and this requires 8 bits for the product term to be stored, hence a total of 8192 bytes i.e. 8 KB and so duplicating this for a shadow buffer only requires a total of 16 KB fast storage means for the significand product tile which is very modest for an ASIC or FPGA embodiment.

The novel device relies upon an efficient shifting operation of the padded tile that is a subtensor of ₛI* [37] which shifting forms a filter center aligned subtensor of size T×T within a padded tensor of size (T+pad)×(T+pad) as described in FIG. 2 and referred to with the *(p,q) annotation which if implemented in a unified linear memory space comprises a simple base indexed addressing means which is suitable for instance for a typical CPU or GPU implementation. However, with a direct electronics implementation as a pipeline of processing in an ASIC or FPGA such a memory indexing means though possible may incur some delays that could limit the maximum clock rate of the pipeline and since the entire tile needs to be shifted then in parallel then this results in a very complex memory addressing means. A more efficient though less general means is to provide a separate row shifting and column shifting means one point location at a time using only local bus connectivity which is simple to implement in electronics so that a maximum of ±P in-column shifts and ±Q in-row shifts is supported wherein the padded (T+pad)×(T+pad) tile is vectorised firstly into a set of P rows within a Q stage pipeline of such wherein each element of each row is multiplexed to receive the data from any one of three elements from the corresponding row in the previous pipeline stage and these three elements being the corresponding row position and its two immediate neighbours and a selection means is provided that selectively shifts each row in the input tile by one position either direction in the row or has no shift and the shift in each row is the same for a given stage in the pipeline and this shift is arranged so that the total shift over the pipeline is q which is the row shift required for the *(p,q) indexing means, and further the output of the last register in the pipeline is connected to the first register in a second similar pipeline with P stages which connection transposes the position of rows and columns so that the second pipeline is identical to the first in operation but is arranged to shift the data p points within each column and for instance this, transposing means could be simply provided by signal routing paths directly or by a cross-point switch means adapted for efficiently performing this compactly, and at the final stage of the second pipeline the output *(p,q) is taken as the subset of T×T register positions from the nominal *(0,0) shift position and in vectorised format corresponding to the desired sop and q shifted output tile noting that the vectorised format laid out in silicon is likely best laid out linearly to be compact and that all connectivity for data flow within the pipeline registers is local and so very compact, further noting that this output is still in transposed order and so connection to the next stage of the pipeline is further provided to undo this transposition to restore the lanes vector to row order, and so by feeding the vectorised padded data tile through the Q stage row shift pipeline then transposing the output and connecting to the input of the P stage column shift pipeline then the padded data tile may be efficiently shifted in position according to the *(p,q) shifting operation to provide a vector of shifted data for the means ₙMᵢ*^{(p,q)} [5], ₑMᵢ*^{(p,q)} [41], and ₛIᵢ*^{(p,q)} [26], and the pipeline is synchronous to the device pipeline though it incurs a latency of P+Q clock cycles noting that the pipeline length limits the maximum 2D size of the filters that may be processed to (2.P+1)×(2.Q+1) so for instance if P=5 and Q=5 then the maximum filter size supported is 11×11 which is very large in the context of a convolutional neural net noting that these filters may be sparse also, and with a direct electronics implementation with 1024 SIMD lanes this only requires a total register storage capacity of (P+Q).1024 words i.e. 10 k words and some silicon area to perform the routing of the transposing means.

Building on the 16 bit fixed point example noting that optionally a shared separate exponent may be implicit in the number in addition to the binary point position, advantage may be taken of the sequential nature of the accumulation one filter coefficient at a time by pipelining the computation of the sum of the tensor R_{f,i,p,q} [12] with the selected accumulator slice A_{f} [25] using a simple 1 bit addition means with carry output and optional carry input from the previous accumulation. In the case that all coefficients corresponding to a 2D input slice are processed sequentially then the current accumulator does not need to be stored between the sequentially presented coefficients that belong to the same filter since they relate to the same accumulator in this case. For the case where coefficients do not relate to the same accumulator, i.e. they relate to other filters, the accumulator tensor along with the bitwise carry output tensor may be input into a shift register pipeline that has means to add the carry input for each bit to the shift register value and for the case of a 16 bit fixed point numerical format the shift register requires 16 stages which shift register comprises per stage a bitwise add of the register contents with the corresponding carry output of the previous register stage which carry for the first stage of the shift register is the carry output of the addition means [13] and each stage outputs both the sum and its corresponding carry for each bit in the register and so as the accumulator slice is moved through the shift register then the carry input from [13] ripples through by addition until the sum of R_{f,i,p,q} [12] with A_{f} [25] is completed and available at the output of the last stage of the shift register. This then permits a very simple embodiment of the addition means [13] as a simple per bit addition without carry input and in this example with 16 separate 1 bit binary adders and the carry result of this is processed with a carry adding shift register means of 16 stages each of which performs addition of the register contents with the carry output of the previous stage using separate 1 bit binary adder means noting that the first stage requires 16 such 1 bit adder means and then each successive stage requires one fewer adder means as the carry ripples through from the least significant bit to the most significant in steps synchronous with the shift register. Such a simple 1 bit binary adding is an extremely fast computational means and is extremely cheap to implement in ASIC or FPGA logic compared to synchronous adder designs such as carry look-ahead for instance and has the minimal possibly latency in its computation, and many lanes of such can be combined to form a very wide SIMD vector and so the device illustrated in FIG. 1 embodies the complex and expensive convolutional filter bank computation with only simple memory means and tile shifting means and 1 bit adder means which are inexpensive to implement in ASIC or FPGA electronics so resulting in in a very compact and low power device capable of performing many hundreds or thousands of parallel computations synchronously and at very high clock rate and so offering a large competitive advantage compared to state-of-the-art devices that operate with 8 bit integer or float16 or float 32 operands and employ direct multiplication or grouped and fused multiply and add.

A second variant of the embodiment of FIG. 1 comprises a virtualised intermediate significand result tensor ₛI_{i,v}*^{(m)} [26] in which instead of storing the intermediate coefficient significand scaled input ₛI [36] or its padded version ₛI* [37] it is computed on-the-fly directly from the padded input annotated as ₛM* so replacing the means [35] [36] [37] and ₛI_{i,v}*^{(p,q)} is computed by adapting the indexing means [27] so that v instead of indexing into ₛI_{i,v} now is an operand to the memory read operation indexes into ₛMᵢ* that is the i^{th} 2D slice of the zero padded ₛM [34] which indexing is via a small look up table (LUT) of v.v entries each 2.(b+1) bits wide that output result from this table is the product of (2^{b}+v) and the fractional part of the value in ₛMᵢ*^{(p,q)} noting that the most significant bit that is not fractional can be zero and this LUT is addressed by concatenating the fractional value from ₛMᵢ*^{(p,q)} and v and the result of the LUT is then gated with the MSB of ₛMᵢ*^{(p,q)} so that if this bit is zero the output result is then also zero otherwise it is the output of the LUT, and thereby this *(p,q) indexing into ₛMᵢ followed by the LUT operation and gating operation performs the identical function in two steps that ₛI_{i,v}*^{(p,q)} performs in a single step, and LUT and gating means can be thought of as a special instruction code and means within a processor. Note that in the example of 1024 SIMD lanes 1024 such LUT's are required and so both the intermediate tensor and virtualised embodiments require approximately the same total memory storage though the ₛI_{i,v}*^{(p,q)} variant requires one less operation and so likely requires less power expenditure and has one less stage of pipeline delay.

A typical operation for a convolutional filter is to add a fixed bias term to the output O [18] one bias per filter applied to each point in the output tile for that filter and this is numerically equivalent to initialising each accumulator slice A_{f} [25] with the bias value that could be positive or negative or zero, so accordingly means are supplied optionally to set the accumulator tensor result corresponding to each filter with a bias value for instance by supplying a storage means that is processor accessible for this vector of bias values so that these values may be set by software means and then loaded into the accumulator before accumulating the output result tensor for the filter bank.

Another option for the accumulator storage means is to supply this off-device within a custom FIFO memory storage means, i.e. a FIFO memory device. Accordingly one embodiment for the accumulator storage means comprises an extremely high speed synchronous data transfer means to and from an externally supplied FIFO device and further ensuring all access for write and read is synchronous and in a predetermined sequential order.

The coefficient sequential processing of the device is not dependant on the order of processing the coefficients but if two or more in the sequence lie within the same slice of the filter kernel then the accumulator A_{f} [25] tensor is the same for those coefficients, so in this case accordingly the accumulator does not need to be stored and fetched from A and a means is further provided to recirculate the previous addition result back to A_{f} [25] and in particular the carry of each bit is separately recirculated to the next accumulation so that a bitwise single bit addition may be performed and thereby at a much higher rate than a synchronous adder with the benefit of simpler logic thereby.

The embodiment for the novel device may comprise custom electronics for supplied by a custom ASIC or FPGA configuration, or software running on a processor or combination thereof.

The precision of the significand of the input data and filter coefficients is 2 or 3 or 4 or 5 or 6 bits.

The exponent for the input data and filter coefficients is 3 or 4 or 5 or 6 or 7 or 8 or 9 bits but not limited thereto.

The numeric format of the accumulator is optionally fixed point e.g. between 8 and 32 bits for instance 16 bits and either has a separate sign bit or has a two's complement format.

The numeric format of the is optionally floating point format for instance with 8 or 16 or 32 bit format such as IEEE 754 16 or 32 bit format but not limited thereto.

The real number formatted input and output tensors either have separate significand, exponent, and optional sign tensors or these are packed into a single tensor wherein each value has all parts packed into a single element.

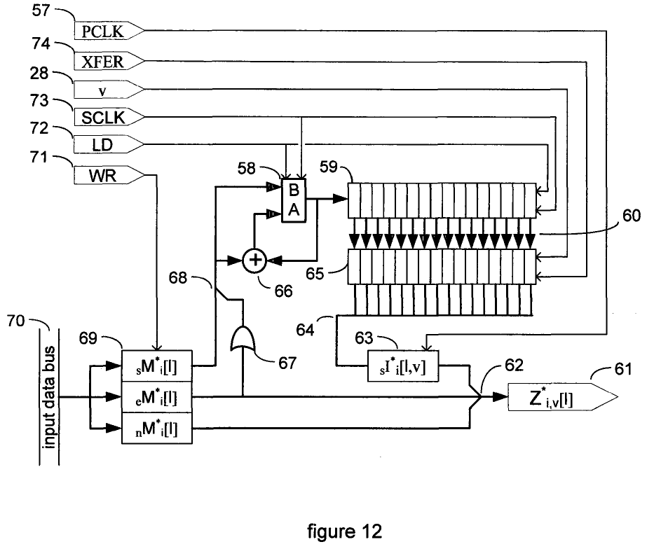

FIG. 12 shows an embodiment of the means to compute and store the intermediate product ₛI* [37] of FIG. 1 as a look up table (LUT) for one point referred to as a lane within a tile of data in which the LUT is indexed by v [28] that is part of the indexing means [27] and the embodiment in the figure performs the function of means [33] [35] [36] [37] and the v indexing part of [27], and in which embodiment a shadow LUT [59] is arranged as a vector of 2^{b} elements which LUT once fully computed is loaded synchronously in parallel by connecting bus means [60] so that each element within the shadow LUT [59] is transferred to the corresponding LUT element in the active LUT [65] that is arranged identically as a vector of 2^{b} elements, and the figure shows a single SIMD lane of a multi-lane device that is thereby arranged to process the entire tile of input data in synchronous SIMD parallel, and wherein each lane receives its single data value from the input data bus [70] and stores this in memory register [69] which storing is synchronised to the data bus transfer by control signal means WR [71] that enables the register to store its input bits and preferably many such lanes are synchronised to have their input valued stored at the same time to facilitate fast transfer from the input data bus which is arranged in width accordingly, which data stored in [69] comprises packed together the sign bit ₘM*ᵢ[I] and the exponent ₑM*ᵢ[I] and the significand ₛM*ᵢ[I] of the data value for the lane where the * indicates that the input tile is padded so some lanes accordingly receive a padding value, and the tile is a subtensor of the input tensor for a range of 2D (y,x) position and a given depth index i and is arranged as a vector where the bracketed [I] indicates that this is lane index I of the tile vector within the SIMD device so that the column and row index within the tile is implicit in the lane index, and further the exponent part ₑM*ᵢ[I] stored in [69] is arranged to be in the format of IEEE754 half precision floating point but not restricted thereto, and which contains an exponent shift bias that is accordingly dealt with separately by further means to subtract this shift in the numerical reformatting means [11] of FIG. 1, and which exponent in this case comprises 5 bits with the special value of zero that has all bits with value zero that indicates that the data value so expressed is zero and accordingly the significand further has its bits combined by logical OR means [67] to produce a single bit result that is either zero if the so expressed data value is zero or is one for a non-zero data value, and this bit is further arranged to be concatenated by means [68] as the most significand bit with the significand ₛM*ᵢ[I] stored in [69] and here this concatenated result is referred to for convenience as SIG, and the significand ₛM*ᵢ[I] for instance but not limited thereto comprises 4 bits that is the fractional part of the significand with precision b=4 and thereby the output bit of OR means [67] is the leading most significant bit before the binary point of the explicit floating point significand so concatenated by [68] to form SIG that has 5 bits, and further the lane processing device has means to compute and store the LUT in an element sequential order starting with value SIG<<(1+b) that is arranged as the preloaded initial value for the accumulator register [58] routed from [68] via its “B” input arranged to be controlled and synchronised by the load control signal means LD [72], and each element of the LUT that is computed and available at the output of [58] is arranged to be stored in sequence into the shadow LUT storage means [59], and further the accumulator [58] and adder [66] and LUTs [59] and 65] are arranged to have 2(b+1) bits of precision so for instance for the case b=4 that has a 5 bit explicit significand then the adder has 10 bits and the accumulator has 10 bits and stores a maximum value of binary 11111×11111 i.e. 1111000001, and further the combined means [58] and [66] and SIG [68] arranges to add the current accumulator output value to the fixed value SIG and store it back to the accumulator [58] via it's “A” input on each clock pulse of SCLK [73] which clock pulse is also further arranged to synchronously load the current output of the accumulator [58] into the LUT storage means [59] which is arranged as an array of memory registers that are written in sequence and which sequence is reset to the first position by the load control signal LD [72] at the beginning of the sequence, and so this sequential adding and storage means thereby is arranged to control the LUT computing and storing process as a sequence of 2^{b} clock cycles and here as an example with b=4 then this is 16 such clock cycles noting that the first cycle is arranged to synchronise the storage of the value SIG<<(1+b) to the first LUT location, and so by this sequential adding means of SIG to the accumulator that has initial value of SIG<<(1+b) then the LUT is computed and stored one element at a time and by arranging a multiplicity of such computing devices one for each lane of the SIMD device this thereby is arranged to form the SIMD LUT for one entire tile of ₛIᵢ* [37] of FIG. 1 i.e. a tile sized subtensor of it, and the lane device further has means to transfer and store this shadow LUT [59] to the active LUT [65] using control means XFER [74] arranged to provide a signal to activate this transfer so that each element of shadow LUT [59] is transferred to its corresponding element in active LUT [65] via connecting arrangement [60], and further a single element at a time of the active LUT [65] is arranged to be selected and routed to the bus [64] which bus is multiplexed from the entire set of elements in the LUT for instance using a common output bus and which element is arranged to be selected and routed to the common output bus by the current filter coefficient index v [28] which output is the fractional part of the current coefficient significand and so in this case of b=4 is 4 bit, and thereby the v^{th} indexed element within the LUT [65] is output to the bus [64] and this so selected value referred to here as ₛIᵢ* [l,v] which indicates lane l of the tile with value that is the product of the binary value 1. ₛM*ᵢ[l] multiplied by 1.v or 0.v as appropriate where the dot “.” is the binary point position, and this so selected product term from LUT [65] is further stored in memory register means [63] which storage is synchronised to the pipeline clock PCLK [57] of the computational device of FIG. 1 and which pipeline clock synchronises all data transfers relating to the main computational pipeline, and finally the selected significand product term [63] which in this case of b=4 is 10 bits wide is concatenated with its sign bit ₙM*ᵢ[l] and its exponent bits ₑM*ᵢ[l] which concatenation is indicate by means [62] which in practice means that the bits form a bus in the silicon layout wherein the order of concatenation is unimportant but should be consistent for the next stage in the pipeline, and this combined data word is stored in memory register means [61] referred to here as Z^{*}_{i,v}[l] without a subscripted prefix since it combines all components of the numerical format, and the subscript of v and bracketed index [l] indicate that this is lane l of the tile for the coefficient with fractional significand with value v, and by all the means so described in FIG. 12 for a multiplicity of such lane processing means arranged one such lane per point within the data tile, e.g. 34×34 tile has 1156 such lanes, then each value within the input padded data tile is arranged to be multiplied by the single scalar value that is the explicit significand of the coefficient ₛW_{f,i,p,q} [32] of FIG. 1 noting that this shadow LUT [59] is computed without any multiplications and is computed in parallel to the operation of the main pipelined computation of the device in figure and the shadow LUT is then arranged to be synchronously transferred to the active LUT [65] when the active data tile has been completely processed for all filter coefficients in the filter bank and thereby the main pipeline is not delayed by the computation of the LUT and which computation may be performed at a slower rate if desired so as to conserve power noting that there is a greater power consumption for faster clock rates and digital switching so it is desirable that the LUT clock is somewhat slower than the pipeline clock and in this case the design of the adder means [66] which in this example is 10 bit can be adapted to reduce power consumption accordingly using any adder design in the prior art.

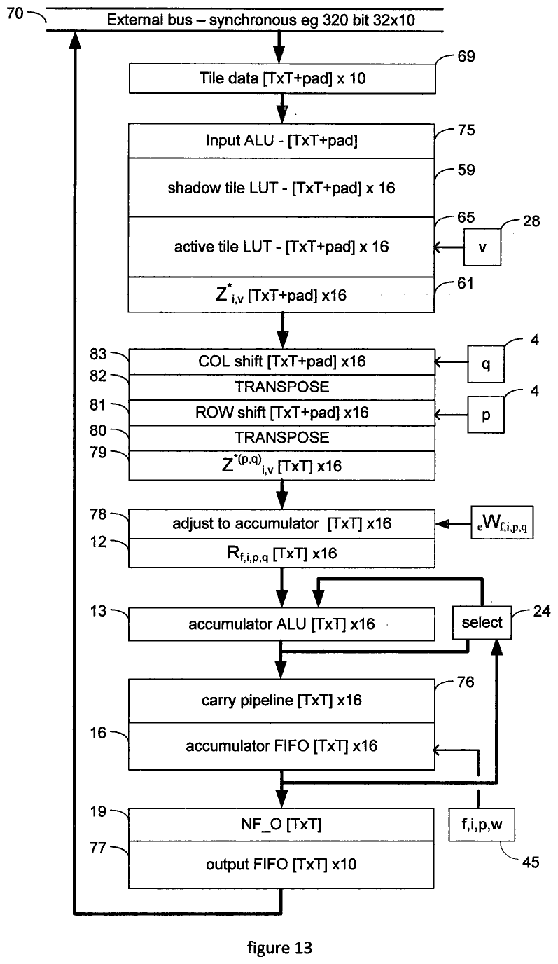

FIG. 13 is an embodiment of the device of FIG. 1 for an input tile of size (T+padding)×(T+padding) points that produces an output tile of size T×T as previously introduced and has a means to compute the shadow LUT [59] and active LUT [65] described in FIG. 12 and here comprises (T+padding)×(T+padding) of such SIMD devices in lanes and to make the example more concrete the 10 bit packed input data representation of the embodiment of FIG. 12 is arranged but limited thereto, and this input is loaded in groups for example of 32 lanes at a time but not limited thereto from the input data bus [70] that thereby is 10×32 bits wide, i.e. 320 bits, and these lanes are loaded in groups into the input data register vector [69] that contains (T+padding)×(T+padding) separate registers simplified to (T×T+pad) where Pad stands for all lanes that contain padding points and so the memory used is [T×T+pad]×10 bits where the square brackets are used to indicate the SIMD vector length and for the 2D input) data tile case this data is arranged in row order, and further the sequential computation means [58] [66] [67] [68] of FIG. 12 are combined into means [75] as a multiplicity of [T×T+pad] lanes which is referred to here as the “Input ALU” whose input data is supplied in SIMD parallel lanes from the equal number of lanes in the input register [69] and which ALU output is arranged to be sequentially stored into the shadow tile LUT [59] that has a corresponding number and arrangement of lanes and in this example of 10 bit floating point packed input the LUT entries are 16 bit to pack the 1 bit sign and 5 bit exponent and 10 bit product term noting that also a lower precision of product term could be employed for instance 5 or 6 or 7 or 8 or 9 bit to reduce memory use at the risk of minor reduction in computational precision, and further the shadow LUT [59] output is arranged as with FIG. 12 to be loaded in a single synchronous parallel operation to the active LUT [65] that has a corresponding number and arrangement of lanes, and the active LUT [65] is arranged to be indexed by v [28] that is the coefficient significand index common to all lanes for a particular pipeline clock cycle within the coefficient sequential processing pipeline that deals with a single coefficient per pipeline clock [57] cycle, and further the so selected product term from the LUT for each lane is arranged to be loaded to the output register [61] that has a corresponding number and arrangement of lanes so that this output register in this example is now 16 bits wide per lane comprising 1 bit sign and 5 bit exponent and 10 bit significand and holds the padded tile in vector format with each lane being the corresponding real number in the input data lane multiplied by binary 1.v where dot “.” here is the binary point and v is the coefficient fractional significand as well as the index since V[v]=1.v and in this case of b=4 has 16 possible values from 1.0000 to 1.1111 in ascending sequence order further noting that this integer product term carries an exponent bias of 2b, and further this padded output tile vector Z*_{i,v} is arranged to be input to the column shift means [83] that is a pipeline of Q registers each with input multiplexers that either passes the lane data to the next stage without lane position change or optionally moves each lane value to either of its immediate neighbours arranged so that at the exit of the column shift means the lane data has moved q [4] lanes, and further the output of the column shift means [83] is connected via tile transposition means [82] to the row shift means [81] that performs the same operation as the column shift means[83] that due to the transposition of the lane order now is arranged to shift lanes between neighbouring rows, and further the output of the row shift means [81] is further arranged to have the lane position transposed by means [80] so that the row and column order of the lanes is restored to the original order i.e. same as that of the output of means [61] but with a shift and by such column and row shifting means then the lane position of the data within the tile is shifted in row position by p [4] and column position by q [4] so performing the *(p,q) shifting means of the indexing means [3] [27] [40] combined for lanes that contain values with packed sign bit and exponent bits and significand bits, and this so shifted tile Z*^{(p,q)}_{i,v} is arranged to be stored in memory means [79] that is arranged to have T×T lanes selected from the totality of lanes to omit those lanes whose index lies within the original padding lanes of the input tile [69], and the output of [79] is further arranged to be processed by means [78] that combines the operation of means [9][10][11][41][42] and that thereby firstly adjusts the exponent of each lane by adding the exponent of the coefficient ₑW_{f,i,p,q} [8] and further subtracts the implicit exponent excess of 2b, noting that the significand of 2(b+1) bits has a binary point with position 2b, and then adding the lane exponent [41] that is packed within the lane's value as the exponent field and then further adjusting the value so computed per lane to the accumulator's numeric format and binary point position that in this example is chosen to be 16 bit fixed point so that the 10 bit significand requires to be bit width extended and padded with zeros and be shifted in position according to the binary point bias of the accumulator numeric format that is arranged as needed with nominal bias of zero and arranged in position to prevent numerical overflow for typical filter sizes and number of coefficients for the typical workload for which the device is arranged and indeed the accumulator may optionally have a variable bias that is adjusted to prevent overflow or underflow dynamically i.e. it is arranged as a floating point format, and the output of this adjustment means [78] is the real valued product of the shifted input data tile and the currently selected filter coefficient is stored in [T×T] SIMD memory means R_{f,i,p,q} [12] that is further arranged to be added by SIMD adder means [13], that in this case is a 16 bit adder, to the corresponding accumulator value that is selected by means [24] that either arranges to select the output of [13] that is the previous accumulator ALU output value in the case that the current coefficient belongs to the same filter as the immediately previously processed coefficient or is alternatively arranged to select the output of the accumulator FIFO [16] which is arranged to be synchronised to the coefficient presentation so that the accumulator for the filter of the current coefficient is the current output of this FIFO, and in this example the 16 bit adder is arranged as a vector of 16 simple 1-bit adders with input and output carry corresponding to each bit in the 16 bits of the accumulator, and further carry routing arrangement is provided so that in the case that the previously processed coefficient belongs to the same filter as the current coefficient then the carry output of the accumulator is recirculated to the carry input of the accumulator with 1 bit left shift so that sequential adding of coefficients from the same filter performs a pipelined addition of both the input values and the carry output of the previous addition, and further in the case that the next coefficient does not belong to the same filter as the current coefficient then the output of the accumulator including the 16 bit carry is arranged to be input to a pipelined SIMD carry adding means [76] arranged to process the carry per lane as previously described so that after 15 stages of the pipeline then the summing process is complete, and further the output of the carry pipeline is input to the accumulator FIFO [16] that is a sequential write memory that is arranged in length that may be variable so that it is synchronised to the accumulation means [13] to present the accumulator value that corresponds to the current filter coefficient indexed by (f,i,p,q) [45], and further when all filter coefficients within the filter bank have been processed by processing the tile at all depths i in the input data tensor then the values in the accumulator FIFO means [16] are arranged to be numerically reformatted by means [19] to the same format as the input data tile in [69] that in this case converts from 16 bit fixed point signed format to 10 bit floating point format with 4 bits of fractional significand and IEE754 half precision float 5 bit exponent and 1 bit sign, and further the reformatted output of the means [19] is arranged to be transferred to the FIFO storage means [77] arranged of sufficient size to store the accumulators one for each filter for each SIMD lane for the largest expected filter bank size and this transfer may optionally be arranged to be overlapped with processing the final tile 2D slice of the input tensor by arranging a separate bypass means for the accumulator FIFO [16] so that the output of the carry pipeline [76] is arranged to be input directly into the numerical reformatting means [19], and so the stored final reformatted accumulator output that corresponds one tile of O [18] that has packed sign and exponent and significand tensors of [20][21][22] in FIG. 1 is further arranged to be connected to the external data bus [70] of the SIMD device for transfer out of the device and which bus may optionally be a separate bus so that data tiles may be loaded while the previous filter bank output is transferred out of the FIFO [77].

Optionally the accumulator [16] format is a floating point format for instance IEEE 754 full or half precision but not limited thereto and other significand precisions for instance from 5 to 21 bits and other exponent widths for instance 4 or 6 or 7 bits are also possible.

Optionally a separate updatable coefficient binary enable mask may be arranged so that coefficients not enabled within the mask are arranged to be skipped and thereby not processed within the coefficient sequential processing pipeline.

Optionally a separate updatable filter binary enable mask may be arranged so that all coefficients within filters that are not enabled within the mask are arranged to be skipped and thereby not processed so that the pipeline processes a reduced total number of coefficients and produces a reduced depth of output tensor and thereby has a lower output memory transfer bandwidth by supporting the omission of entire filters while preserving the skipped values in the coefficient tensor.

Since the order of presentation of both filters and coefficients if of no consequence to the values accumulated and output to O [18] then optionally the coefficients are arranged to be presented in an order so that those coefficients that have the same index values (v,p,q) are presented in sequence one after the other the order within each group being of no consequence and further the pipeline for performing the indexing operation [27] is frozen, i.e. the pipeline clock is not presented, once the first coefficient in the group has been indexed and as this set of values in the SIMD device moves through the downstream pipeline then the previous elements of the pipeline also are arranged to have their pipeline clock disabled until the values corresponding to the first coefficient in the next (v,p,q) group are presented at which point the corresponding stage of the pipeline is enabled again so that referring to the example embodiment of FIG. 13 then means [61] [65] [79] [80] [81] [82] [83] are all disabled in order as the values corresponding to the group (v,p,q) pass through them and in this case the accumulator ALU [13] adds the frozen values output from Z*^{(p,q)}_{i,v} [79] after reformatting by means [78] to each corresponding filter accumulator in the group in turn and thereby the power consumption in the disabled part of pipeline corresponding to means [27] for the group of coefficients is essentially reduced to the parasitic level as the clock is not active and data is not flowing. So while the coefficients of a (v,p,q) group are being sequentially processed then the operation of the pipeline is reduced to a simple exponent adding and barrel shift followed by adding the so shifted tile to the corresponding accumulator.

A further embodiment takes advantage of the case where coefficients with the same (v,p,q) are presented in sequence one after the other as in the previous paragraph by providing means to shift the partial convolution result R_{f,i,p,q} by one row position or one column position at a time in either direction in-place within a single tile memory means for instance by multiplexing of the individual elements of the tile to their row and column neighbours combined with a control mechanism synchronised for instance to the pipeline clock so that within a (p,q) group the tile is not shifted and (p,q) are varied in sequence for fixed v that indexes one significand product tile so arranged in sequence so as to minimise the number of shifts between group elements and ideally so that only a single shift in either p or q is performed between (p,q) groups, and this shifting is arranged so that multiple shifts in either row or column or both positions allows the tile to be shifted an arbitrary number of steps along the row and columns of the tile in-place, i.e not in a pipeline of tiles and this reduces the electronics complexity, and further the sequencing of coefficients may be arranged to optimally reduce the number of shifting operations in synchrony with the downstream convolution accumulation pipeline and in particular arranged to avoid pipeline stalls. and further the padded tile in this in-place shifting means is arranged presented to tile centred subtensor means 61 synchronised to the pipeline so that the (p,q) shifted tile whose value is the padded Z_{i,v}*^{(p,q)} is presented to the subtensor means that extracts its center tile that is thereby not padded so that the downstream pipeline may further process as previously described for instance as an electronics embodiment.

A further embodiment is presented wherein the input ALU is arranged to update its value in sequence of v from 1 to b with p and q further arranged to be sequenced for all active filter coefficients that share this significand v so that the operation of the convolution of the input data tile with the filter coefficients tensor is arranged to be performed while avoiding the LUT operation and while avoiding saving of all LUT entries for each value of v since the ALU now only contains the current v during the sequence and so simplifying the computation within the device.

A software embodiment that arranges the shifting means as a based indexed addressing to extract the center (0,0) shifted subtensor R_{f,i,p,q}*^{(p,q)} and for instance this may be further arranged to be extracted as a set of vectors one vector at a time such as one row of the tile at a time within a vector that is arranged for SIMD vector processing for the downstream pipeline.

1.-23. (canceled)

24. A processor device that performs a 3D convolutional filter operation suitable for performing the convolutional operations within a convolutional neural net in which a real valued 4D tensor bank W of filters each 3D filter W_{f} of which is applied at all 2D (y,x) locations, i.e. spatial dimensions over which the convolution is performed, to a real valued 3D input tensor M that is split into identically sized tiles that are presented in sequence to the device in which each tile is a stack of depth D of 2D slices and which 2D slices are arranged to be presented to the device in turn so that it may be convolved with the corresponding slice of the filters each of kernel depth D in the bank in order to sequentially compose and accumulate the convolutional 3D output tile tensor which is a tensor of accumulators of the same 2D size as the input tile and with a depth equal to the number of filters in the bank, the processor device comprising:
means that arranges the input tile and filter coefficients to be represented and stored in a real valued format with a finite and low arithmetic precision significand, a separate exponent that is for instance between 3 and 9 bits inclusively, and a sign bit that is optional for the input tile, and in particular the significand precision is arranged with between 3 and 5 bits inclusively and preferably is 4 bits so that there are only a small number of unique significand values, and in which the significand of both data and filter coefficients is further arranged before presenting to the device to be rounded to the nearest quantized value for the chosen significand precision which is vital to the accuracy of the neural convolutional operation to avoid systematic bias in the result;
means that arranges to pad the input tensor with data from bordering input tiles or zeros around its boundary with a sufficiency of padding adapted to the 2D size of the filter kernels in W so that the 2D size of the convolution output tile has the same 2D size as the unpadded input tile, and in the case that data is padded around the tile border then this may be arranged for instance by simply presenting such a larger data padded tile to the device at its input;
control means that sequences the filter coefficients in each filter in the bank to be selected in turn according to the order desired for processing each filter coefficient within each 2D slice through the filter bank corresponding to the currently presented 2D input slice;
means for computing and storing the product of the significands in the input tile with all possible significand values for the chosen significand precision which is a small set of possible significand values for instance 16 values for a 4-bit significand which means in this case arranges to be computed 16 significand product 2D tiles one for each of the possible significand values, which means is a key novel inventive feature;
means that arranges the stored significand product computation results to be shared across the convolution computation for all coefficients in the 2D slice through all filters within the filter bank for the current input tile so that this sharing avoids computing the significand product for each filter coefficient and the input tile separately since many coefficients share the same significand value at low significand precision, which sharing means comprises selecting into the stored significand product results so that the 2D significand product tile is selected according to the significand value for the currently sequenced coefficient provided by the coefficient sequencing means, and arranges the so selected tile to be presented at the stored significand product output so that this tile corresponds to the product of the significands of the input tile with the significand of the currently sequenced coefficient, and thereby the product of the significand of the coefficient with the input significand tile is arranged at this output without performing multiplication which is a key inventive step;
a shifting and sub-tensor selection means that arranges to form a filter center aligned 2D sub-tensor for each of the selected significand product tile and the corresponding input exponent and sign tiles that all are padded, which means selects a sub-tensor of the 2D size of the input tile from those padded tensors at the 2D shifted position of the coefficient relative to the kernel center so that the so selected sub-tensors are in positional registration with and of the same size as both the unpadded input tile and the corresponding convolution accumulation output tile;
means to combine the so selected filter kernel center aligned sign, exponent, and significand product tiles into a single 2D tile of the same numerical format as the accumulator tile corresponding to the currently selected filter coefficient ready to be elementwise added to that accumulator tile, which numerically reformatted real valued tile is thereby the partial convolution result 2D tile R_{f,i,p,q} for the currently sequenced filter coefficient, which format for instance is a floating point format that has higher significand precision than the input tile to reduce overflow or underflow, and for example arranged as IEEE float32, or alternatively in a suitable precision fixed point format whose binary point position is arranged according to the desired numerical range and precision for the convolution accumulation arranged to reduce under- and over-flow during the accumulation process, and preferably a floating point format;
means for elementwise adding the numerically reformatted partial convolution result 2D tile to the corresponding filter accumulator 2D tile which is arranged to be selected and presented to the elementwise adding means along with the partial convolution result tile so that the corresponding position elements of each are added to form an output 2D tile of the same size as the two operand tiles so arranging the elementwise sum of these, and the sum tile is further arranged to be stored back to and overwrite the selected accumulator tile once the elementwise adding operation has completed, and thereby the selected accumulator tile is updated by elementwise adding with the numerically reformatted partial convolution result 2D tile so that once all filter coefficients have been so sequenced and accumulated then the accumulator tile for each filter is thereby arranged to contain the complete convolution result of each filter with the input tile and be in positional registration with the input tiles that have been presented in sequence during this coefficient sequential and input tile slice sequential convolution process;
means that arranges, once the convolution operation has completed across all filter coefficients and all 2D slices of the input tile, to select the accumulator tiles in order and arrange for each in turn to be numerically reformatted back to the low precision format of the input tile and in particular the significand is rounded to the nearest quantized value which is important in a convolutional neural net to avoid systematic bias in activation maps, and further arranges that the numerically reformatted low precision output accumulator tiles are presented sequentially in order to the output of the device;
and an electronic processor means adapted to performing the means of the device as described above such as custom electronics arranged as an ASIC or configured FPGA, or software running on a processor, or combination thereof, or indeed any combination of these on a single chip or across a multiplicity of interconnected chips.

25. The device according to claim 24, wherein:
the device further comprises:
means to compute the significand product tile for each unique significand value in an ascending sequential order, the coefficients in the filter bank being sequenced in the same ascending significand value order with arbitrary order within each group that shares the same significant value, which sequential order starts with the smallest value unique significand which for precision b=4 is 10000 in explicit significand format that has most significant bit of 1, and in which this first lowest value significand product tile is arranged as the input significand tile left shifted by b bits and further arranged with the explicit most significant bit extended with binary one so arranging the explicit significand representation, and
means to load this computed tile into an accumulator tile of registers arranged for this purpose, and all subsequent significand product tiles in increasing numerical order are further arranged to be computed in a sequential process of adding the b bit input significand tile elementwise to this accumulator tile using adding means provided for this purpose and thereby forming each intermediate significand product tile in turn in the accumulator in a sequence starting at the smallest unique significand value and ending at the largest and for instance for b=4 this forms 16 product tiles each of 10 bit precision with the binary point at bit position 2.b=8, and by so arranging the significand product tile to be computed in sequence then this avoids precomputing and storing the significand product tile for all possible significand values and avoids selecting a product tile since the coefficients are sequenced in step with the accumulation of the significand product tile.

26. The device according to claim 24, wherein the filter bank is 3×3 or 1×1 in the 2D convolution dimensions.

27. The device according to claim 24, wherein the filters within the filter bank are sparse so that one or preferably many of the coefficients of a correspondingly shaped dense filter bank are arranged thereby to be omitted, and thereby the total number of coefficients sequenced in the convolution computation is reduced so reducing the total number of steps in the convolution accumulation process.

28. The device according to claim 24, wherein a separate updatable coefficient binary enable mask is arranged so that coefficients not enabled within the mask are arranged to be skipped by the coefficient sequencing means and thereby not processed so reducing the total number of steps in the convolution accumulation process.

29. The device according to claim 24, wherein a separate updatable filter binary enable mask is arranged so that all coefficients within filters that are not enabled within the mask are arranged to be skipped by the coefficient sequencing means and thereby not processed so reducing the total number of steps in the convolution accumulation process.

30. The device according to claim 24, further comprising:
means is arranged to set the accumulator tensor result corresponding to each filter with a bias value for instance by supplying a storage means that is processor accessible for this vector of bias values so that these values may be set under the control of software and then loaded into the accumulator before accumulating the output result tensor for the filter bank.

31. The device according to claim 24, wherein a per point computation means is further provided to the output of the filter accumulators such as scaling or a nonlinear function operation such as a positive clipping known as Relu, and this operation is further arranged to be performed to the accumulator output after completion of the final accumulation operation in the convolution process and before the final numerical reformatting back to the format of the input data tile.
